(19) United States
(12) Patent Application Publication
(10) Pub. No.: US 2025/0002425 A1
(43) Pub. Date: Jan. 2, 2025

(54) CORROSION INHIBITORS FOR NITRAPYRIN CONTAINING AGRICULTURAL FORMULATIONS

(71) Applicant: Verdesian Life Sciences U.S., LLC, Cary, NC (US)

(72) Inventors: Janice Paletta, Durham, NC (US); Kuide Qin, Chapel Hill, NC (US); Gary Orr, Pittsboro, NC (US)

(21) Appl. No.: 18/690,368

(22) PCT Filed: Aug. 29, 2022
(86) PCT No.: PCT/US2022/041859

§ 371 Date: Mar. 8, 2024

Related U.S. Application Data
(60) Provisional application No. 63/243,421, filed on Sep. 13, 2021.

(51) Int. Cl. C05G 3/90; C05G 5/23; C23F 11/14

(52) U.S. Cl. CPC C05G 3/90; C05G 5/23; C23F 11/141

(57) ABSTRACT

The presently disclosed subject matter is directed corrosion inhibitor formulation containing amine-based corrosion inhibitor components and select solvents that generally can be co-formulated with any nitrapyrin-containing composition to generate noncorrosive nitrapyrin formulations that exhibit reduced corrosion behavior when exposed to metal-based surfaces. Such noncorrosive nitrapyrin formulations find particular utility in agricultural uses, e.g., directly applied to soil, or in combination with fertilizers to increase nutrient uptake and to inhibit nitrification and urease hydrolysis. Prepartion of such noncorrosive nitrapyrin-containing formulations are also disclosed.

### FIELD

The presently disclosed subject matter relates to a corrosion inhibitor composition comprising an amine-based corrosion inhibitor and a solvent. Such compositions are useful as co-formulants for formulations containing nitrification inhibitor nitrapyrin, which are often employed in agricultural uses to increase nutrient uptake and promote plant growth.

### BACKGROUND

Nitrogen fertilizer added to the soil is readily transformed through a number of biological and chemical processes. One of such processes is nitrification, where soil bacteria metabolizes the ammonium form of nitrogen in the soil thereby transforming the nitrogen into nitrite and nitrate forms, which are more susceptible to nitrogen loss through leaching or volatilization via denitrification. Nitrification inhibitors have been developed to inhibit such nitrogen loss due to nitrification. One class of nitrification inhibitors in use is composed of various chlorinated compounds related to pyridine, as taught by Goring in U.S. Pat. No. 3,135,594 (incorporated herein in its entirety by reference). Nitrapyrin is an example of such a nitrification inhibitor.

Current nitrapyrin-containing formulations are often mixed with liquid nitrogen fertilizer solution (e.g., UAN and anhydrous ammonia) or coated onto the granular nitrogen fertilizer (e.g., urea). Unfortunately, contact of the formulated nitrapyrin-containing composition with water, either through the liquid fertilizer solution or moisture from the air, can cause failure of the equipment that is used to apply the nitrapyrin-incorporated fertilizer products due to the corrosivity of the nitrapyrin-containing formulation. The corrosion is typically observed in the metal components of the fertilizer application equipment where the components are in contact with the nitrapyrin formulation. The equipment failure causes downtime during the limited fertilizer application season and significant economic losses.

Efforts to reduce corrosion behavior of current nitrapyrin-containing formulations involve formulating nitrapyrin in non-corrosive solvents with the drawback that the level of nitrapyrin in such formulation is significantly lower compared to nitrapyrin formulations that employ solvents exhibiting increased corrosion.

Therefore, it would be highly desirable to find a way to not only improve nitrapyrin formulations with respect to increasing their concentration and/or reducing nitrapyrin volatilization but also to develop formulations that are less corrosive, more economical, less toxic, and less harmful to the environment.

### BRIEF SUMMARY

In one aspect, the subject matter described herein is directed to corrosion inhibitor composition for nitrapyrin-containing compositions comprising an amine-based corrosion inhibitor selected from a neutralizing amine, a film-forming amine, and a combination thereof; and a solvent selected from a glycol ether, a methylated seed oil, and a combination thereof, wherein the amine-based corrosion inhibitor is present at a concentration of at least 50% by weight based on the total weight of the corrosion inhibitor composition.

In one aspect, the subject matter described herein is directed to a noncorrosive nitrapyrin formulation comprising a nitrapyrin-containing composition; a corrosion inhibitor composition as disclosed herein; and an organic solvent.

In one aspect, the subject matter described herein is directed to a method of making a noncorrosive nitrapyrin formulation, comprising contacting a nitrapyrin-containing composition with a corrosion inhibitor composition as disclosed herein to form a noncorrosive nitrapyrin formulation

In one aspect, the subject matter described herein is directed to a method of reducing corrosion of metal-based material used in agricultural equipment, the method comprising: obtaining a noncorrosive nitrapyrin formulation as disclosed herein; and contacting a metal-based surface with the noncorrosive nitrapyrin formulation for a period of time.

These and other aspects are fully described below.

### DETAILED DESCRIPTION

The presently disclosed subject matter will now be described more fully hereinafter. However, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. In the event that one or more of the incorporated literature, patents, and similar materials differs from or contradicts this application, including but not limited to defined terms, term usage, described techniques, or the like, this application controls. Unless otherwise defined, all technical and scientific terms used herein have the same meaning as commonly understood by one of ordinary skill in this field. All publications, patent applications, patents, and other references mentioned herein are incorporated by reference in their entirety.

Advantageously, the compositions, formulations and methods described herein have been shown to provide desirable properties for the use of nitrapyrin in agriculture by formulating nitrapyrin and compositions thereof with a corrosion inhibitor composition to render noncorrosive nitrapyrin formulations. Other aspects described herein include compositions, formulations, and methods of employing the disclosed corrosion inhibitor compositions to modulate the corrosion behavior of nitrapyrin-containing formulations.

It was unexpectedly observed that formulations containing nitrapyrin in combination with a corrosion inhibitor composition as disclosed herein exhibit a reduced level of corrosion towards materials used in agricultural equipment, particularly metal-based materials, compared to other nitrapyrin-containing formulations. Surprisingly, when such a corrosion inhibitor composition comprising an amine-based corrosion inhibitor and a solvent is added as a co-formulant to nitrapyrin-containing compositions, undesirable corrosive properties of the nitrapyrin-containing compositions are significantly reduced.

A reduced level of corrosion is particularly important as it not only provides a significant increase in user-friendliness of these formulations when used with agricultural equipment but also provides many other benefits, such as, but not limited to, a decrease in wear and tear of agricultural equipment and/or its components providing increased longevity of the equipment and components thereof, less maintenance of the agricultural equipment when not exposed to a corrosive environment, increased safety of using such formulations combination with metal-based equipment, etc.

Agricultural equipment becomes chemically more stable by the formation of a passivation oxide layer (a thin film on the surface of the material that stops access of the corrosive substance to the metal-based equipment), inhibiting either the oxidation or reduction part of the redox corrosion system, or by scavenging the dissolved oxygen. While using an agrichemical composition with a reduced level of corrosion reduces the risk of salt formation in fin-fan coolers, heat exchangers, pump arounds and tanks.

A reduced level of corrosion provides significant economical value via the pumping and transportation of agricultural composition in non-corrosive metal-based reservoirs, as well as protects the environment from contamination.

### II. Definitions

As used herein, the term “chemical stability” refers to the resistance of a substance to structurally change when exposed to an external action such as air (which can lead to oxidation), light (e.g., sunlight), moisture/humidity (from water), heat (from the sun), and/or chemical agents. Exemplary chemical agents include, but are not limited to, any organic or inorganic substance that can degrade the structural integrity of the compound of interest (e.g., the disclosed nitrapyrin-polyanionic polymer complex). Chemical stability is also used to evaluate the stability of a formulation when determining its shelf life. Components of a formulation exhibit a certain chemical stability when exposed to storage conditions such as air (which can lead to oxidation), light (e.g., sunlight), moisture/humidity (from water), heat (from the sun), and/or chemical agents.

As used herein, the term “thermal stability” refers to the stability of a substance when exposed to thermal stimuli over a given period of time. Examples of thermal stimuli include, but are not limited to, heat generated from an electrical source and/or heat generated from the sun.

As used herein, the term “corrosion” refers to the gradual destruction of materials (usually a metal-based) by chemical and/or electrochemical reaction with their environment. For example, corrosion can be a process that converts a refined metal into a more chemically stable form such as oxide, hydroxide, or sulfide. It is the gradual destruction of materials (usually a metal-based) by chemical and/or electrochemical reaction with their environment. In the most common use of the word, this means electrochemical oxidation of metal-based materials in reaction with an oxidant such as oxygen or sulfates. Rusting, the formation of iron oxides, is a well-known example of electrochemical corrosion. This type of damage typically produces oxide(s) or salt(s) of the original metal and results in a distinctive orange coloration. Corrosion can also occur in materials other than metals, such as ceramics or polymers, although in this context the term “degradation” is more common. Corrosion degrades the useful properties of materials and structures including strength, appearance and permeability to liquids and gases.

The “corrosion inhibitors” are the compounds that, when added to a fluid, decrease the corrosion rate of a metal-based surface or an alloy. The effectiveness, or corrosion inhibition efficiency, of a corrosion inhibitor is a function of many factors like: fluid composition, quantity of composition, flow regime, etc. If the correct inhibitor and quantity is selected then it is possible to achieve a high, 99%, efficiency.

As used herein, the term “soil” is to be understood as a natural body comprised of living (e.g., microorganisms (such as bacteria and fungi), animals and plants) and nonliving matter (e.g., minerals and organic matter (e.g., organic compounds in varying degrees of decomposition), liquid, and gases) that occurs on the land surface and is characterized by soil horizons that are distinguishable from the initial material as a result of various physical, chemical, biological, and anthropogenic processes. From an agricultural point of view, soils are predominantly regarded as the anchor and primary nutrient base for plants (plant habitat).

As used herein, the term “fertilizer” is to be understood as chemical compounds comprising plant nutrients applied to promote plant and fruit growth. Fertilizers are typically applied either through the soil (for uptake by plant roots) or by foliar feeding (for uptake through leaves). The term “fertilizer” can be subdivided into two major categories: a) organic fertilizers (composed of decayed plant/animal matter) and b) inorganic fertilizers (composed of chemicals and minerals). Organic fertilizers include manure, slurry, worm castings, peat, seaweed, sewage, and guano. Green manure crops are also regularly grown to add nutrients (especially nitrogen) to the soil. Manufactured organic fertilizers include compost, blood meal, bone meal and seaweed extracts. Further examples are enzymatically digested proteins, fish meal, and feather meal. The decomposing crop residue from prior years is another source of fertility. In addition, naturally occurring minerals such as mine rock phosphate, sulfate of potash and limestone are also considered inorganic fertilizers. Inorganic fertilizers are usually manufactured through chemical processes (such as the Haber-Bosch process), also using naturally occurring deposits, while chemically altering them (e.g., concentrated triple superphosphate). Naturally occurring inorganic fertilizers include Chilean sodium nitrate, mine rock phosphate, and limestone.

As used herein, the term “manure” is organic matter used as organic fertilizer in agriculture. Depending on its structure, manure can be divided into liquid manure, semiliquid manure, stable or solid manure, and straw manure. Depending on its origin, manure can be divided into manure derived from animals or plants. Common forms of animal manure include feces, urine, farm slurry (liquid manure), or farmyard manure (FYM), whereas FYM also contains a certain amount of plant material (typically straw), which may have been used as bedding for animals. Animals from which manure can be used comprise horses, cattle, pigs, sheep, chickens, turkeys, rabbits, and guano from seabirds and bats. The application rates of animal manure when used as fertilizer highly depend on the origin (type of animals). Plant manures may derive from any kind of plant whereas the plant may also be grown explicitly for the purpose of plowing them in (e.g., leguminous plants), thus improving the structure and fertility of the soil. Furthermore, plant matter used as manure may include the contents of the rumens of slaughtered ruminants, spent hops (left over from brewing beer) or seaweed.

As used herein, the term “seed” comprises seed of all types, such as, for example, corns, seeds, fruits, tubers, seedlings, and similar forms. The seed used can be seed of the useful plants mentioned above, but also the seed of transgenic plants or plants obtained by customary breeding methods.

As used herein, the term “solvent” refers to a nonaqueous solvent (wherein a nonaqueous solvent is a solvent that contains no more than 2%, 1%, 0.5%, or 0.2% by weight water based on the total weight of the nonaqueous solvent) that solvates the nitrapyrin-containing composition, the amine-based corrosion inhibitor composition, and/or the noncorrosive nitrapyrin formulation as described elsewhere herein.

As used herein, the term “inhibit urease” and the like refer to the inhibition of the activity of urease. The inhibition can be quantified as described elsewhere herein.

As used herein, “N-Serve®” refers to a composition comprising nitrapyrin at a concentration of 25.97% relative to the total solution. The solution comprises petroleum distillates as a solvent. The composition is formulated at a concentration of 2 lbs of active ingredient (nitrapyrin) per gallon.

As used herein, “Instinct® II” refers to a composition comprising nitrapyrin at a concentration of 16.95% relative to the total solution. The solution comprises petroleum distillates as a solvent. The composition is formulated at a concentration of 1.58 lbs of active ingredient (nitrapyrin) per gallon.

Throughout this specification and the claims, the words “comprise,” “comprises,” and “comprising” are used in a nonexclusive sense, except where the context requires otherwise, and are synonymous with “including,” “containing,” or “characterized by,” meaning that it is open ended and does not exclude additional, unrecited elements or method steps.

As used herein, the term “about,” when referring to a value, is meant to encompass variations of, in some embodiments, ±5%, in some embodiments ±2%, in some embodiments ±1%, in some embodiments ±0.5%, and in some embodiments ±0.1% from the specified amount, as such variations are appropriate to perform the disclosed methods or employ the disclosed compositions.

Additional definitions may follow below.

### III. Corrosion Inhibitor Compositions

Corrosion inhibitor compositions containing an amine-based corrosion inhibitor selected from a neutralizing amine, a film-forming amine, or a combination thereof and a solvent selected from a glycol ether, a methylated seed oil, and a combination thereof, have been prepared. These corrosion inhibitor compositions have shown to be very useful when added as co-formulants to nitrapyrin-containing compositions for the purpose of reducing the corrosion behavior of the nitrapyrin-containing composition when exposed to a metal-based or plastic-based surface. This anti-corrosion behavior of the disclosed corrosion inhibitor compositions was very surpring and unexpected.

In general, the corrosion inhibitor compositions can be added to any composition containing nitrapyrin, i.e., any commercially available compositions and/or solutions containing nitrapyrin (e.g., Instinct II, N-Serve) and/or any prepared nitrapyrin-containing composition as disclosed herein. Prepared nitrapyrin-containing compositions disclosed herein are either neat or can include a solvent (e.g., an organic solvent).

It was unexpected and surprising to discover that corrosion inhibitor compositions showed anti-corrosion properties when used as a co-formulant with nitrapyrin-containing compositions. Not to be bound by theory, but it is believed that the solubility properties of the corrosion inhibitor composition is important with respect to its anti-corrosion ability. More specifically, it is crucial that the corrosion inhibitor composition is formulated in a manner that allows for the miscibility of the corrosion inhibitor composition when added to the nitrapyrin-containing formulation. If the two components are immicible with each other the anti-corrosion properties decrease.

In some embodiments, the described corrosion inhibitor composition contains relatively little to no water. Compositions containing high amounts of water have shown rapid degradation of nitrapyrin and therefore the exposure of nitrapyrin-containing compositions to excessive amounts of water when contacted with the corrosion inhibitor compositions as disclosed herein should be minimized. In some embodiments, the amount of water present in the corrosion inhibitor composition or in a formulation thereof is less than about 10%, about 9%, about 8%, about 7%, about 6%, about 5%, about 4%, about 3%, about 2%, about 1%, or is less than 0.5% w/w based on the total weight of the composition or formulation.

### A. Amine-Based Corrosion Inhibitor

The corrosion inhibitor composition disclosed herein comprises and amine-based corrosion inhibitor selected from a neutralizing amine, a film-forming amine, and a combination thereof.

In general, neutralizing amines are compounds (e.g., weak bases) that control corrosion by neutralizing corrosive species (that are typically acidic in nature). In some embodiments, the amine-based corrosion inhibitor reduces corrosion of any metal-and or plastic-containing surface or parts and/or components of agricultural equipment that is contacted by such amine-based corrosion inhibitors and/or compositions and/or formulations containing such amine-based corrosion inhibitors disclosed herein.

Neutralizing amines employed in the disclosed corrosion inhibitor composition are selected from ammonia (NH3), cyclohexylamine (CHA), methoxypropylamine (MPA), monoethanolamine (MEA), morpholine (MOR), 3-methoxypropylamine (MOPA), ethylamine (ET), dimethylamine (DMA), 1,8-Diazabicyclo(5.4.0)undec-7-ene (DBU), 2-diethylaminoethanol (DEAE), monoethanolamine (EA), triethanolamine (TEA), dicthanolamine (DEA), diethylhydroxylamine (DEHA), methyldiethanolamine (MDEA), and a combination thereof. In some embodiments, the neutralizing amine present in the amine-based corrosion inhibitor is selectes from ethanolamine (EA), diethanolamine (DEA), methyldiethanolamine (MDEA), and a combination thereof. In some embodiments, the neutralizing amine is monoethanolamine (MEA). In some embodiments, the neutralizing amine is monoethanolamine (EA). In some embodiments, the neutralizing amine is diethanolamine (DEA). In some embodiments, the neutralizing amine is methyldiethanolamine (MDEA). In some embodiments, the neutralizing amine is selected from ethanolamine (EA), diethanolamine (DEA), methyldiethanolamine (MDEA), and a combination thereof.

Film-forming amines are compounds that provide corrosion protection by forming a physicochemical barrier between the metallic surface (e.g., of the agricultural equipment) and the working solution (e.g., formulation) to prevent corrosion from occurring. In some embodiments, the film-forming amine is an amine of formula (I):

R₁—[NH—R₂]ₙ—NH₂
wherein n is an integer between 0 and 7,
R₁ is a substituted or unsubstituted (C₁-C₂₂) alkyl group, and
R₂ is a substituted or unsubstituted (C₂-C₁₀) alkyl group.

In some embodiments, n is 0. Such film-forming amines are referred to as monoamines. Exemplary monoamines include, but are not limited to, methylamine, ethylamine, propylamine, n-butylamine, n-pentylamine, n-hexylamine, n-heptylamine, n-octylamine, n-nonylamine, n-decylamine, and/or n-undecylamine. In some embodiments, the monoamine is a fatty amine. Exemplary fatty amines include, but are not limited to, dodecylamine, tridecylamine, tetradecylamine, pentadecylamine, hexadecylamine, heptadecylamine, octadecylamine, nondecylamine, eicosylamine, heneicosylamine, or docosylamine.

In some embodiments, n is not 0. Such film-forming amines are referred to as polyamines. Exemplary polyamines include, but are not limited to, an amine of formula (I), wherein n is an integer selected from 1, 2, 3, 4, 5, 6, and 7; R₁ is a substituted or unsubstituted (C₁-C₂₂) alkyl group; and R₂ is a substituted or unsubstituted (C₂-C₁₀) alkyl group. In some embodiments, n is an integer selected from 1 and 2.

In some embodiments, R₁ is a substituted or unsubstituted (C₈-C₂₂) alkyl group. In some embodiments, R₁ is a substituted or unsubstituted (C₁₂-C₁₈) alkyl group. In some embodiments, R₁ is a substituted or unsubstituted (C₂-C₈) alkyl group.

In some embodiments, R₂ is a substituted or unsubstituted (C₂-C₁₀) alkyl group. In some embodiments, R₂ is a substituted or unsubstituted (C₂-C₈) alkyl group. In some embodiments, R₂ is a substituted or unsubstituted (C₂-C₆) alkyl group.

In some embodiments, the amine-based corrosion inhibitor is selected from one or more neutralizing amines. In some embodiments, the amine-based corrosion inhibitor is selected from one or more film-forming amines. In some embodiments, the amine-based corrosion inhibitor is a combination of one or more neutralizing amines and film-forming amines. In such embodiments, the weight ratio of the one or more neutralizing amines and one or more film-forming amines ranges from about 1000:1 to about 1:1000, from about 100:1 to about 1:100, from about 10:1 to about 1:10, from about 5:1 to about 1:5, from about 2:1 to about 1:2, or 1:1.

The amount (or concentration) of the amine-based corrosion inhibitor present in the corrosion inhibitor composition can vary. In such embodiments, the amount of amine-based corrosion inhibitor(s) ranges from about 10% to about 99% by weight, from about 20% to about 99% by weight, from about 30% to about 99% by weight, from about 40% to about 99% by weight, from about 50% to about 99% by weight, from about 60% to about 99% by weight, from about 70% to about 99% by weight, from about 80% to about 99% by weight, from about 90% to about 99% by weight, or from about 95% to about 99 by weight based on the total weight of the amine-based corrosion inhibitor composition. In some embodiments, the amount (or concentration) of the corrosion inhibitor composition ranges. In some embodiments, the amount of the amine-based corrosion inhibitor present in the corrosion inhibitor composition is at least about 10%, 20%, 30%, 40%, 50%, 60%, 70%, 80%, 90%, 95%, or at least about 98% by weight based on the total weight of the corrosion inhibitor composition.

### B. Solvent

In some embodiments, the corrosion inhibitor composition comprises the disclosed amine-based corrosion inhibitor and a solvent selected from a glycol ether, a methylated seed oil, and a combination thereof. In some embodiments, the corrosion inhibitor composition will only contain a solvent selected from a glycol ether, a methylated seed oil, and a combination thereof and there will be no other solvents present, i.e., any organic or aqueous solvents.

In some embodiments, the solvent is a glycol ether. Glycol ethers are a group of solvents based on alkyl ethers of ethylene glycol commonly used in agrichemical compositions. These solvents typically have a low melting point and a higher boiling point, together with the favorable solvent properties of lower molecular weight ethers and alcohols. Exemplary glycol ethers include, but are not limited to, ethylene glycol monomethyl ether, ethylene glycol monoethyl ether, ethylene glycol monopropyl ether (propyl cellosolve), ethylene glycol monoisopropyl ether, ethylene glycol monobutyl ether, cthylene glycol monophenyl ether, ethylene glycol monobenzyl ether, cthylene glycol diethyl ether, ethylene glycol dibutyl ether, ethylene glycol monohexyl ether; propylene glycol methyl ether; diethylene glycol monomethyl ether, diethylene glycol monocthyl ether, diethylene glycol monobutyl ether, diethylene glycol diethyl ether, diethylene glycol dibutyl ether, diethylene glycol monomethyl ether, and diethylene glycol monohexyl ether; dipropylene glycol monobutyl ether, dipropylene glycol methyl ether, 2-butoxyethanol (butyl cellosolve), cthylene glycol monohexyl ether (hexyl cellosolve), tripropylene glycol monomethyl ether, tripropylene glycol monobutyl ether and a combination thereof. In some embodiments, the glycol ether is selected from butyl cellosolve, propyl cellosolve, hexyl cellosolve, diethylene glycol monoethyl ether, dipropylene glycol monomethyl ether, and a combination thereof. In some embodiments, the glycol ether is butyl cellosolve. In some embodiments, the glycol ether is hexyl cellosolve.

In some embodiments, the solvent is a surfactant comprising methylated vegetable oil, alcohol ethoxylate, tall oil fatty acid, and a combination thereof. In some embodiments, the solvent is methylated seed oil.

In some embodiments, the solvent is selected from butyl cellosolve, propyl cellosolve, hexyl cellosolve, diethylene glycol monoethyl ether, dipropylene glycol monomethyl ether, methylated seed oil, and a combination thereof.

In some embodiments, the amine-based corrosion inhibitor is ethanolamine and the solvent is selected from butyl cellosove, hexyl cellusolve, triethylene glycol monomethyl ether, methylated seed oil, and a combination thereof.

In some embodiments, the solvent is butyl cellosolve and the amine-based corrosion inhibitor is selected from ethanolamine, diethanolamine, and a combination thereof.

The amount of the solvent present in the corrosion inhibitor composition can vary. In such embodiments, the amount of solvent ranges from about 0.01% to about 99% by weight, from about 10% to about 99% by weight, from about 20% to about 99% by weight, from about 30% to about 99% by weight, from about 40% to about 99% by weight, from about 50% to about 99% by weight, from about 60% to about 99% by weight, from about 70% to about 99% by weight, from about 80% to about 99% by weight, from about 90% to about 99% by weight, or from about 95% to about 99 by weight based on the total weight of the corrosion inhibitor composition. In some embodiments, the amount of solvent present in the corrosion inhibitor composition ranges from about 0.01% to about 50%, from about 1% to about 50%, from about 10% to about 50%, from about 20% to about 50%, from about 30% to about 50%, or from about 40% to about 50% by weight based on the total weight of the corrosion inhibitor composition.

In some embodiments, the amount solvent present in the corrosion inhibitor composition is no more than about 50%, 45%, 40%, 35%, 30%, 25%, 20%, 15%, 10%, 5%, or not more than 1% by weight based on the total weight of the corrosion inhibitor composition.

It was unexpected and surprising to discover that when amine-based corrosion inhibitors were formulated with solvents containing glycol ethers and/or surfactants that the resulting corrosion inhibitor composition exhibited anti-corrosion properties when used as a co-formulant with nitrapyrin-containing compositions. Not to be bound by theory, but it is believed that the solubility properties of the corrosion inhibitor composition is important with respect to its anti-corrosion ability. More specifically, it is crucial that the amine-based corrosion inhibitor is formulated in a solvent that allows for the miscibility of the corrosion inhibitor composition when added to the nitrapyrin-containing formulation. If the two components are not misicible with each other the anticorrosion propoteries decrease.

In some embodiments, the corrosion inhibitor composition can be formulated as a corrosion inhibitor formulation comprising an organic solvent. The type of organic solvent can vary and is discussed in more detail below.

### IV. Nitrapyrin-Containing Composition

As mentioned above, the corrosion inhibitor composition can be added to nitrapyrin-containing composition as further described in more detail below. Furthermore, the nitrapyrin-containing compositions disclosed herein can also be a component of the non-corrosive nitrapyrin formulation described in more detail in the formulation section in this application. In general, the nitrapyrin-containing composition contains nitrification inhibitor nitrapyrin, which has the following structure:

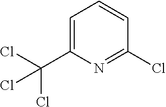 [SMILES: Clc1cccc(C(Cl)(Cl)Cl)n1]

Nitrapyrin functions to inhibit nitrification within the soil bacteria, Nitrosomonas, which act on ammonia by oxidizing ammonium ions to nitrite and/or nitrate. Nitrification inhibition therefore reduces nitrogen emissions from soil.

In some embodiments, the nitrapyrin-containing composition disclosed herein comprises nitrapyrin, commercially available nitrapyrin-containing solutions, or a combination thereof.

The amount of nitrapyrin in the disclosed nitrapyrin-containing composition can vary. In some embodiments, the amount of the nitrapyrin in the nitrapyrin-containing solution is greater than 15% by weight based on the total weight of the nitrapyrin-containing solution, for example from about 15% to about 30% by weight, from about 15% to about 28% by weight, from about 15% to about 26% by weight, from about 15% to about 23% by weight, from about 15% to about 20% by weight, from about 15% to about 18% by weight, or greater than 16% by weight, greater than 17% by weight, greater than 18% by weight, greater than 19% by weight, greater than 20% by weight, greater than 21% by weight, greater than 22% by weight, greater than 23% by weight, greater than 24% by weight, greater than 25% by weight, greater than 26% by weight, greater than 27% by weight, greater than 28% by weight, greater than 29% by weight, greater than 30% by weight, greater than 35% by weight, greater than 40% by weight, or greater than 45% by weight based on the total weight of the nitrapyrin-containing composition. In some embodiments, the composition comprise nitrapyrin in an amount of at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50% by weight based on the total weight of the composition.

In some embodiments, the nitrapyrin-containing composition contains neat nitrapyrin, that is nitrapyin in its original form. In some embodiments, the nitrapyrin-containing composition comprises nitrapyrin and an organic solvent.

In some embodiments, the nitrapyrin-containing composition comprises nitrapyrin-containing commercially available solutions. Exemplary nitrapyrin-containing commercially available compositions and/or solutions are Instinct® II and/or N-Serve®, but are not limited thereto. In some embodiments, the nitrapyrin-containing composition comprises one or more nitrapyrin-containing commercially available compositions/solutions and a solvent. In some embodiments, the solvent is an organic solvent.

The amount of solvent can vary. In some embodiments, the amount of solvent is from about 10% to about 90% by weight, from about 20% to about 85% by weight, from about 50% to about 85% by weight, or from about 60% to about 80% by weight based on the total weight of the composition. In some embodiments, the amount of solvent is from about 10% to about 85% by weight, from about 25% to about 85% by weight, from about 30% to about 85% by weight, or from about 40% to about 85% by weight based on thet total weight of the composition. In some embodiments, the amount of solvent is less than 85% by weight, less than 84% by weight, less than 83% by weight, less than 82% by weight, less than 81% by weight, less than 80% by weight, less than 79% by weight, less than 78% by weight, less than 77% by weight, less than 76% by weight, less than 75% by weight, less than 74% by weight, less than 73% by weight, less than 72% by weight, less than 71% by weight, less than 70% by weight, less than 65% by weight, less than 60% by weight, or less than 55% by weight based on the total weight of the nitrapyrin-containing composition. In embodiments, the amount of solvent is from 55% to about 98% by weight; from about 60% to about 97% by weight; from about 61% by weight to about 95% by weight; from about 62% to about 90% by weight; from about 63% to about 85% by weight; or from about 64% to about 80% by weight based on the total weight of the nitrapyrin-containing composition.

In some embodiments, the described nitrapyrin-containing composition contains relatively little to no water. Compositions containing high amounts of water have shown rapid degradation of nitrapyrin and therefore the exposure of nitrapyrin-containing compositions to excessive amounts of water should be minimized. In some embodiments, the amount of water present in the nitrapyrin-containing composition or in a formulation thereof is less than about 10%, about 9%, about 8%, about 7%, about 6%, about 5%, about 4%, about 3%, about 2%, about 1%, or is less than 0.5% w/w based on the total weight of the composition or formulation. In such formulations and/or compositions, the chemical stability of the nitrapyrin is at least about 50%, about 60%, about 70%, about 80%, about 85%, about 90%, about 91%, about 92%, about 93%, about 94%, about 95%, about 96%, about 97%, about 98%, about 99%, or at least about 99.5%. See, for example, Meikle et al. “The hydrolysis and photolysis rates of nitrapyrin in dilute aqueous solution” Arch. Environ. Contam. Toxicol. 7, 149-158 (1978).

### A. Organic Solvents

The organic solvent present in the nitrapyrin-containing composition can be one or more polar organic solvents. In some embodiments, the one or more polar organic solvents are EPA approved. EPA-approved solvents are those that are approved for food and non-food use and found in the electronic code of federal regulations, for example in Title 40, Chapter I, Subchapter E, Part 180. EPA-approved solvents include, but are not limited to, the organic solvent listed in Table 1.

TABLE 1
EPA-approved organic solvent

| | |
|---|---|
| 1,3-Propanediol (CAS Reg. No. 504-63-2) | Isopropyl-3-hydroxybutyrate (CAS Reg. |
| | No. 54074-94-1) |
| 2-Ethylhexanol | Kerosene, U.S.P. reagent |
| 2-methyl-1,3-propanediol (CAS Reg. | Lactic acid |
| No. 2163-42-0) | |
| 2-Methyl-2,4-pentanediol | Lactic acid, 2-ethylhexyl ester (CAS Reg. |
| | No. 6283-86-9) |
| Acetic anhydride | Lactic acid, n-propyl ester, (S); (CAS Reg. |
| | No. 53651-69-7) |
| Acetone (CAS Reg. No. 67-64-1) | Mesityl oxide |
| Ammonium hydroxide | Methyl 5-(dimethylamino)-2-methyl-5- |
| | oxopentanoate (1174627-68-9) |
| Amyl acetate | Methyl alcohol |
| Benzyl acetate (CAS Reg. No. 140-11-4) | Methyl esters of fatty acids derived from |
| | edible fats and oils |
| C₁₀₋₁₁ rich aromatic hydrocarbons (CAS | Methyl isobutyl ketone |
| Reg. No. 64742-94-5) | |
| C₁₁₋₁₂ rich aromatic hydrocarbons (CAS | Methyl isobutyrate (CAS Reg. |
| Reg. No. 64742-94-5) | No. 547-63-7) |
| C₉ rich aromatic hydrocarbons (CAS Reg. | Methyl n-amyl ketone (CAS Reg. |
| No. 64742-95-6) | No. 110-43-0) |
| Choline chloride (CAS Reg. No. 67-48-1) | Mineral oil |
| Cod liver oil | Morpholine 4-C₆₋₁₂ Acyl Derivatives (CAS |
| | Reg. No. 887947-29-7) |
| Cyclohexane | n-Butanol (CAS Reg. No. 71-36-3) |
| Cyclohexanone | n-Butyl benzoate (CAS Reg. No. 136-60-7) |
| Decanamide, N,N-dimethyl (CAS Reg. | n-Butyl-3-hydroxybutyrate (CAS Reg. |
| No. 14433-76-2) | No. 53605-94-0) |
| Diethylene Glycol (CAS No. 111-46-6) | n-Decyl alcohol (CAS Reg. No. 112-30-1) |
| Diethylene glycol mono butyl ether (CAS | n-Hexyl alcohol (CAS Reg. No. 111-27-3) |
| Reg. No. 112-34-5) | |
| Diethylene Glycol MonoEthyl Ether (CAS | N-Methylpyrrolidone (CAS Reg. |
| Reg. No. 111-90-0) | No. 872-504) |
| Diethylphthalate | n-Octyl alcohol (CAS Reg. No. 111-87-5) |
| Diisopropyl adipate (CAS Reg. | n-Propanol |
| No. 6938-94-9) | |
| Dimethyl adipate (CAS Reg. No. 627-93-0) | Octanamide, N,N-dimethyl (CAS Reg. |
| | No. 1118-92-9) |
| Dimethyl glutarate (CAS Reg. No. | Oxo-decyl acetate (CAS reg. |
| 1119-40-0) | No. 108419-33-6) |
| Dimethyl succinate (CAS Reg. No. 106-65- | Oxo-heptyl acetate (CAS Reg. |
| 0) | No. 90438-79-2) |
| Dimethyl sulfoxide (CAS Reg. No. | Oxo-hexyl acetate (CAS Reg. |
| 67-68-5) | No. 88230-35-7) |
| Di-n-butyl carbonate (CAS Reg. | Oxo-nonyl acetate (CAS Reg. |
| No. 542-52-9) | No. 108419-34-7) |
| Dipropylene glycol | Oxo-octyl acetate (CAS Reg. |
| | No. 108419-32-5) |
| Distillates, (Fischer-Tropsch), heavy, | Oxo-tridecyl acetate (CAS Reg. |
| C₁₈-C₅₀, branched, cyclic and linear (CAS | No. 108419-35-8) |
| Reg. No. 848301-69-9) | |
| d-Limonene (CAS Reg. No. 5989-27-5) | Petroleum hydrocarbons, light odorless |
| | conforming to 21 C.F.R. § 172.884 |
| Edible fats and oils | Phenol |
| Ethyl acetate | Propanoic acid, 2-methyl-, monoester with |
| | 2,2,4-trimethyl-1,3-pentanediol (CAS Reg. |
| | Reg. No. 25265-77-4) |
| Ethyl alcohol | Propylene glycol |
| Ethyl esters of fatty acids derived from | Propylene glycol monomethyl ether (CAS |
| edible fats and oils | Reg. No. 107-98-2) |
| Ethylene glycol (CAS Reg. No. 107-21-1) | Soybean oil-derived fatty acids |
| Glycerol mono-, di-, and triacetate | Tall oil fatty acid (CAS Reg. |
| | No. 61790-12-3) |
| Hydrochloric acid | Tetraethylene glycol (CAS Reg. |
| | No. 112-60-7) |
| Isobornyl acetate | Toluenesulfonic acid |
| Isobutyl acetate (CAS Reg. No. 110-19-0) | Triacetin (glyceryl triacetate) |
| Isobutyl isobutyrate (CAS Reg. | Xylene |
| No. 97-85-8) | |
| Isobutyric acid (CAS Reg. No. 79-31-2) | γ-Butyrolactone |
| Isopropyl myristate (CAS Reg. | |
| No. 110-27-0) | |

In some embodiments, the organic solvent present in the nitrapyrin-containing composition is selected from a sulfone, a sulfoxide, an oil, an aromatic solvent, a halogenated solvent, a glycol-based solvent, a fatty acid-based solvent, an acetate-containing solvent, a ketone-containing solvent, an ether polyol-containing solvent, an amide-containing solvent, and combinations thereof. In some embodiments, the one or more organic solvents are all relatively free of water. In some embodiments, the organic solvent contains less than about 10% w/w, about 9% w/w, about 8% w/w, about 7% w/w, about 6% w/w, about 5% w/w, about 4% w/w, about 3% w/w, about 2% w/w, about 1% w/w, about 0.9% w/w, about 0.8% w/w, about 0.7% w/w, about 0.6% w/w, about 0.5% w/w, about 0.4% w/w, about 0.3% w/w, or less than about 0.1% w/w of water based on the total weight of the organic solvent. In some embodiments, the organic solvent is a liquid at 20° C.

In some embodiments, the organic solvent present in the nitrapyrin-containing composition is a sulfone. A sulfone solvent can be, but is not limited to, sulfolane, methyl sulfolane (3-methyl sulfolane), and dimethylsulfone, and a combination thereof. In some embodiments, the organic solvent is a sulfoxide. A sulfoxide solvent can be, but is not limited to, dimethyl sulfoxide.

In some embodiments, the organic solvent present in the nitrapyrin-containing composition is an ether polyol. An ether polyol solvent can be, but is not limited to, polyethylene glycols, polypropylene glycols, polyalkylene glycols, and related compounds. In some embodiments, the polyethylene glycol has two terminal alcohols (e.g., polyethylene glycol 3350). Exemplary polyethylene glycols include, but are not limited to, diethylene glycol, tricthylene glycol, and a combination thereof. Exemplary polypropylene glycols include, but are not limited to, dipropylene glycol, tripropylene glycol, and a combination thereof. In some embodiments, a polypropylene glycol has three terminal alcohols. Exemplary polypropylene glycols having three terminal alcohols, known as propoxylated glycerol, include, but are not limited to, Dow PT250 (which is a glyceryl ether polymer containing three terminal hydroxyl groups with a molecular weight of 250) and Dow PT700 (which is a glyceryl ether polymer containing three terminal hydroxyl groups with a molecular weight of 700). In some embodiments, ether polyol comprises a polyethylene or a polypropylene glycol in the molecular weight range of between about 200 and about 10,000 Da. In some embodiments, one or more of the hydroxyl groups present in the ether polyol is modified. For example, in some embodiments, one or more of the hydroxyl groups present in the ether polyol are alkylated and/or esterified. Exemplary modified ether polyols include, but are not limited to, triacetin, n-butyl ether of diethylene glycol, ethyl ether of diethylene glycol, methyl ether of diethylene glycol, acetate of the ethyl ether of dipropylene glycol, and a combination thereof. In some embodiments, the ether polyol is a cyclic carbonate ester (e.g., propylene carbonate). It has been found that the disclosed compositions containing ether polyols are more suitable for formation of higher solids and/or actives content than previously described compositions containing esters.

In some embodiments, the organic solvent present in the nitrapyrin-containing composition is a glycol-based solvent. A glycol is an alcohol that contains two hydroxyl (—OH) groups that are attached to different carbon atoms (e.g., terminal carbon atoms). The simplest glycol is ethylene glycol, although the organic solvent should not be limited thereto. In some embodiments, the organic solvent is propylene glycol, propane-1,2,3-triol, or a combination thereof.

In some embodiments, the organic solvent present in the nitrapyrin-containing composition is an oil. Exemplary oils include, but are not limited to, mineral oil and/or kerosene.

In some embodiments, the organic solvent present in the nitrapyrin-containing composition is a fatty acid-based solvent. In some embodiments, the fatty acid contains between about 3 to about 20 carbon atoms. Example of fatty acid-based solvents include, but are not limited to, a dialkyl amide of a fatty acid (e.g., a dimethylamide). Examples of a dimethylamide of a fatty acid include, but are not limited to, a dimethyl amide of a caprylic acid, Agnique® AMD810 (C8-C10 fatty acid dimethyl amides; CAS Numbers 1118-92-9 and 14433-76-2), Agnique® AMD3L (N,N-dimethylactamide; CAS Number 35123 Jun. 9), and a combination thereof.

In some embodiments, the organic solvent present in the nitrapyrin-containing composition is a ketone-containing solvent. Examples of ketone-containing solvents include, but are not limited to, isophorone, trimethylcyclohexanone, and a combination thereof.

In some embodiments, the organic solvent present in the nitrapyrin-containing composition is an acetate-containing solvent. Examples of acetate-containing solvents include, but are not limited to, acetate, hexyl acetate, heptyl acetate, and a combination thereof.

In some embodiments, the organic solvent present in the nitrapyrin-containing composition is an amide-containing solvent. Examples of amide-containing solvents include, but are not limited to, Rhodiasolv®ADMA10 (CAS Reg. No. 14433-76-2; N,N-dimethyloctanamide), Rhodiasolv®ADMA810 (CAS Reg. No. 1118-92-9/14433-76-2; blend of N,N-Dimethyloctanamide and N,N-dimethyldecanamide), Rhodiasolv® PolarClean (CAS Reg. No. 1174627-68-9; methyl 5-(dimethylamino)-2-methyl-5-oxopentanoate), and a combination thereof.

In some embodiments, the organic solvent present in the nitrapyrin-containing composition is a halogenated solvent. In some embodiments, the halogenated solvent is a halogenated aromatic hydrocarbon. An example of a halogenated aromatic hydrocarbon is chlorobenzene. In some embodiments, the halogenated solvent is a halogenated aliphatic hydrocarbon. An example of a halogenated aliphatic hydrocarbon is 1,1,1-trichloroethane.

In some embodiments, the organic solvent present in the nitrapyrin-containing composition is an aromatic solvent. In some embodiments, the aromatic solvent is an aromatic hydrocarbon. Exemplary aromatic hydrocarbons include, but are not limited to, benzene, naphthalene, and a combination thereof. In some embodiments, the aromatic hydrocarbon is substituted. Examples of substituted aromatic hydrocarbons include, but are not limited to, alkyl substituted benzenes and/or alkyl substituted naphthalenes. Examples of alkyl substituted benzenes include xylene, cumene, toluene, propylbenzene, 2-methylnaphthalene, 1-methylnaphthalene, 1,2,4-trimethylbenzene, 1,3,5-trimethylbenzene and a combination thereof. In some embodiments, the organic solvent comprises xylene. In some embodiments, the aromatic hydrocarbon is a mixture of substituted and unsubstituted aromatic hydrocarbons, such as, but not limited to, a mixture of naphthenic and alkyl substituted naphthalene.

In some embodiments, the aromatic solvent is a mixture of hydrocarbons. For example, in some embodiments, the aromatic solvent is aromatic 100, a solvent containing naphtha (CAS Reg. No. 64742-95-6), which is a combination of hydrocarbons obtained from distillation of aromatic streams consisting predominantly of aromatic hydrocarbons (C₈ through C₁₀), or aromatic 200, a solvent containing a mixture of: aromatic hydrocarbon (C₁₁-C₁₄) present in 50-85% by weight; naphthalene (CAS Reg. No. 91-20-3) present in 5-20% by weight; aromatic hydrocarbon (C₁₀) not including naphthalene present in 5-15% by weight; and aromatic hydrocarbon (C₁₅-C₁₆) present in 5-15% by weight based on the total weight of the aromatic 200 composition. In some embodiments, the aromatic hydrocarbon is a mixture of aromatic 100 and aromatic 200.

In some embodiments, the aromatic solvent is heavy aromatic solvent naphtha (petroleum) (CAS Reg. No. 64742-94-5), which is a complex combination of hydrocarbons obtained from distillation of aromatic streams consisting predominantly of aromatic hydrocarbons having carbon numbers predominantly in the range of C₉ through C₁₆ and boiling in the range of approximately 165° C. to 290° C. (330° F. to 554° F.).

In some embodiments, an organic solvent present in the nitrapyrin-containing composition can be, but is not limited to, an aromatic solvent (such as, but not limited to, alkyl substituted benzene, xylene, propyl benzene, mixed naphthalene and alkyl naphthalene); and mineral oils; kerosene; dialkyl amides of fatty acids, (including, but not limited to, dimethylamides of fatty acids, dimethylamide of caprylic acid); chlorinated aliphatic and aromatic hydrocarbons (including, but not limited to, 1,1,1-trichloroethane, chlorobenzene); esters of glycol derivatives (e.g., n-butyl, ethyl, or methyl ether of diethyleneglycol and acetate of the methyl ether of dipropylene glycol); ketone-containing solvents (e.g., including, but not limited to, isophorone and trimethylcyclohexanonc (dihydroisophorone)); and acetate-containing solvents (including, but not limited to, hexyl and heptyl acetate).

In some embodiments, the organic solvent present in the nitrapyrin-containing composition is selected from a heavy aromatic solvent naphtha (petroleum), aromatic 100, aromatic 200, alkylated benzene, alkyl substituted benzene and/or naphthalene, halogenated aromatic solvents, glycol-based solvents, and a combination thereof.

In some embodiments, nitrapyrin can be formulated with at least two or more different organic solvent types. In some embodiments, nitrapyrin can be formulated in at least two different organic solvent types that can exhibit high solvation. In some embodiments, the at least two different organic solvent types for solvating nitrapyrin are organic solvents selected from 1,2,4 trimethylbenzene, xylenes, 1,3,5 trimethylbenzene, cumene, 2-methylnaphthalene, naphthalene, 1-methylnaphthalene, heavy aromatic solvent naphtha (petroleum), and a combination thereof. In some embodiments, the at least two different organic solvents are a mixture of 1,2,4 trimethylbenzene (CAS Reg. No. 95-63-6), xylene (CAS Reg. No. 1330-20-7), 1,3,5 trimethylbenzene (CAS Reg. No. 108-67-8), and cumene (CAS Reg. No. 98-82-8). In some embodiments, the at least two different organic solvents are a mixture of 2-methylnaphthalene (CAS Reg. No. 91-57-6), naphthalene (CAS Reg. No. 91-20-3), 1-methylnaphthalene (CAS Reg. No. 90-12-0), heavy aromatic solvent naphtha (petroleum)(CAS Reg. No. 64742-94-5), and a combination thereof. In some embodiments, a mixture of 2-methylnaphthalene (CAS Reg. No. 91-57-6), naphthalene (CAS Reg. No. 91-20-3), 1-methylnaphthalene (CAS Reg. No. 90-12-0), heavy aromatic solvent naphtha (petroleum) (CAS Reg. No. 64742-94-5) is further mixed with a glycol-based solvent (e.g., propylene glycol).

The amount of each organic solvent type present in the nitrapyrin-containing composition can vary. In some embodiments, the first organic solvent of the at least two or more different organic solvent types is present in an amount ranging from about 10% to about 90%, from about 20% to about 80%, from about 30% to about 70%, from about 40% to about 60% w/w based on the total weight of the composition. In some embodiments, the second organic solvent of the at least two or more different organic solvent type is present in an amount ranging from about 10% to about 90%, from about 20% to about 80%, from about 30% to about 70%, from about 40% to about 60% w/w based on the total weight of the composition.

In some embodiments, the solvency of the nitrapyrin-containing composition can vary. In some embodiments, the solvency of the nitrapyrin (of formulations comprising nitrapyrin) in solution/organic solvent at 20° C. is greater than 15% w/v (nitrapyrin to total weight), for example from about 15% to about 30% w/v, from about 15% to about 28% w/v, from about 15% to about 26% w/v, from about 15% to about 23% w/v, from about 15% to about 20% w/v, from about 15% to about 18% w/v, or greater than 16% w/v, greater than 17% w/v, greater than 18% w/v, greater than 19% w/v, greater than 20% w/v, greater than 21% w/v, greater than 22% w/v, greater than 23% w/v, greater than 24% w/v, greater than 25% w/v, greater than 26% w/v, greater than 27% w/v, greater than 28% w/v, greater than 29% w/v, greater than 30% w/v, greater than 35% w/v, greater than 40% w/v, or greater than 45% w/v.

The amount of organic solvent present in the nitrapyrin-containing composition can vary. In some embodiments, the amount of organic solvent present in the nitrapyrin-containing composition at 20° C. is less than 85% w/v (organic solvent to total weight), for example, from about 85% to about 70% w/v, from about 85% to about 72 w/v, from about 85% to about 74% w/v, from about 85% to about 77% w/v, from about 75% to about 80% w/v, from about 75% to about 82 w/v, or less than 84% w/v, less than 83% w/v, less than 82% w/v, less than 81% w/v, less than 80% w/v, less than 79% w/v, less than 78% w/v, less than 77% w/v, less than 76% w/v, less than 75% w/v, less than 74% w/v, less than 73% w/v, less than 72% w/v, less than 71% w/v, less than 70% w/v, less than 65% w/v, less than 60% w/v, or less than 55% w/v.

In some embodiments, the amount of organic solvent will be minimized as the amount of nitrapyrin is maximized. In some embodiments, the amount of organic solvent is less than 80% w/v, less than 79% w/v, less than 78% w/v, less than 77% w/v, less than 76% w/v, less than 75% w/v, less than 74% w/v, less than 73% w/v, less than 72% w/v, less than 71% w/v, less than 70% w/v, less than 65% w/v, less than 60% w/v, or less than 55% w/v. In embodiments, the amount of organic solvent is from 55% w/v to about 98% w/v; or from about 60% w/v to about 97% w/v; or from about 61% w/v to about 95% w/v; or from about 62% w/v to about 90% w/v; or from about 63% w/v to about 85% w/v; or from about 64% w/v to about 80% w/v. In some embodiments, the amount of organic solvent is from about 10% w/v to about 90% w/v, from about 20% w/v to about 80% w/v, from about 50% w/v to about 70% w/v, or from about 60% w/v to about 70% w/v. In some embodiments, the amount of organic solvent is from about 10% w/v to about 50% w/v, or from about 10% w/v to about 40% w/v, or from about 10% w/v to about 30% w/v, or from about 10% w/v to about 20% w/v. In some embodiments, the amount of organic solvent is from about 49.9% to about 98.9% w/v, from about 50% w/v to about 90% w/v, or from about 50% w/v to about 80% w/v, or from about 50% w/v to about 70% w/v, or from about 50% w/v to about 65% w/v. In some embodiments, the amount of organic solvent is from about 0.1% w/v to about 20% w/v.

### V. Formulations

The disclosed corrosion inhibitor compositions and/or nitrapyrin-containing compositions can be used in their unmodified original form (e.g., neat) or can be formulated into formulations containing the disclosed corrosion inhibitor composition and/or nitrapyrin-containing composition. In some embodiments, the formulation comprises the corrosion inhibitor composition disclosed herein (referred to as corrosion inhibitor formulation). In some embodiments, the formulation comprises the nitrapyrin-containing compositions disclosed herein (referred to as nitrapyrin-containing formulation). In some embodiments, the formulation comprises the corrosion inhibitor compositions and the nitrapyrin-containing compositions as disclosed herein and are referred to as noncorrosive nitrapyrin formulations.

In some embodiments, the formulations disclosed hercin (i.e., corrosion inhibitor formulation, nitrapyrin-containing formulation and noncorrosive nitrapyrin formulation) comprise one or more additives. Exemplary additives include, but are not limited to, a surface active agent, an antifoam agent, a dispersant, an emulsifier, a stability agent, a basic material or a combination thereof. A skilled artisan would be familiar with these types of additives and would have knowledge of what type of additive would be suitable for employing in the formulations disclosed herein.

In some embodiments, the additive is a surface-active agent (e.g., a surfactant). The term “surfactant” means an amphiphilic compound that comprises a hydrophilic moiety and hydrophobic moiety that lowers the surface tension of a liquid causes the lowering of the interfacial tension between two liquids. In some embodiments, the surface active agent is selected from polyoxyethylene tridecyl ether phosphate (Rhodafac RS-610), ethylene oxide-propylene oxide polymer monobutyl ether (Antarox B848), polyethylene glycol esters of fatty acids (Alkamuls VO/2003), 4-dodecylbenzenesulfonic acid and salts thereof (e.g., dodecylbenzenesulfonate, sodium salt, etc.), and a combination thereof. The amount of surface-active agent in the formulation can vary. In some embodiments, the amount of surface-active agent in the composition and/or formulation is from about 0.1% to about 20%, from about 0.1% to about 10%, from about 1% to about 10%, from about 3% to about 8%, from about 5% to about 8% or from about 10% to about 20%, from about 12% to about 18% or from about 14% to about 16% by weight based on the total weight of the composition and/or formulation.

In some embodiments, the additive is an antifoam agent. Antifoams are agents that reduce the formation of foam in the tank. They can also break the foam already formed in the tank. In some embodiments, the antifoam agent is selected from an oil-based antifoam agent, a powder-based antifoam agent, a water-based antifoam agent, a silicone-based antifoam agent, and EO/PO-based antifoam agent, an alkyl polyacrylate-based antifoam agent, and a combination thereof. Exemplary oil-based antifoam agents include, but are not limited to, mineral oil, vegetable oil, white oil, a wax, or hydrophobic silica. Exemplary waxes include, but are not limited to, ethylene bis stearamide (EBS), paraffin waxes, ester waxes, hydrocarbon waxes, fatty alcohol waxes, and a combination thereof. Exemplary powder-based antifoam agents include, but are not limited to, oil-based antifoam agents on a particulate carrier like silica. Exemplary silicone-based antifoam agents include, but are not limited to, polymers with a silicon backbone, silicon compounds comprising a hydrophobic silica dispersant in a silicone oil, or silicone-treated silica. Exemplary EO/PO-based antifoaming agents include, but are not limited to, ethylene oxide-propylene oxide copolymers. The amount of antifoam agent in the formulation can vary. In some embodiments, the amount of antifoam agent in the composition and/or formulation is from 0.1% to about 20%, from about 0.1% to about 10%, from about 1% to about 10%, from about 3% to about 8%, from about 5% to about 8% or from about 10% to about 20%, from about 12% to about 18% or from about 14% to about 16% by weight based on the total weight of the composition and/or formulation.

In some embodiments, the additive is a dispersant. A “dispersant” or a “dispersing agent” is a substance, that is added to a suspension of solid or liquid particles in a liquid to improve the separation of the particles and to prevent their settling or clumping. In some embodiments, the dispersant is selected from soap powder, turkey red oil, alkyl sulphonates, alkyl acryl sulphonates, formaldehyde, lignin sulphonates, and a combination thereof. The amount of dispersant in the formulation can vary. In some embodiments, the amount of dispersant in the formulation is from 0.1% to about 20%, from about 0.1% to about 10%, from about 1% to about 10%, from about 3% to about 8%, from about 5% to about 8% or from about 10% to about 20%, from about 12% to about 18% or from about 14% to about 16% by weight based on the total weight of the formulation and/or composition.

The above-mentioned additives are meant to be exemplary and it would be apparent to a person skilled in the art as to what additives and their corresponding amounts would be suitable for a formulation comprising a corrosion inhibitor composition and/or a nitrapyrin-containing composition.

Generally, the amount of corrosion inhibitor composition and/or nitrapyrin-containing composition present in the corresponding formulation can vary.

For example, the amount of corrosion inhibitor composition present in a corrosion inhibitor formulation ranges from about 0.1% to about 99.9%, from about 1% to about 98.5%, from about 10% to about 98%, from about 20% to about 97%, from about 30% to about 95%, from about 40% to about 90%, from about 50% to about 85%, from about 60% to about 80%, or from about 65% to about 75% by weight based on the total weight of the formulation. In some embodiments, the amount of corrosion inhibitor composition present in the corrosion inhibitor formulation is at least about 50%, about 60%, about 70%, about 80%, about 85%, about 90%, about 92%, about 95%, or at least about 98% by weight based on the total weight of the formulation.

In some embodiments, the corrosion inhibitor formulation comprises an organic solvent. The type of organic solvent can be the same as described above for the nitrapyrin-containing composition. In some embodiments, the corrosion inhibitor formulation comprises a combination of organic solvents. In some embodiments, the combination of organic solvents is the same combination of organic solvents as described above for the nitrapyrin-containing composition.

In some embodiments, the amount of nitrapyrin-containing composition present in a given formulation can vary. For example, in some embodiments, the amount of nitrapyrin-containing composition present in the nitrapyrin-containing formulation ranges from about 0.1% to about 99.9%, from about 1% to about 98.5%, from about 10% to about 98%, from about 20% to about 97%, from about 30% to about 95%, from about 40% to about 90%, from about 50% to about 85%, from about 60% to about 80%, or from about 65% to about 75% by weight based on the total weight of the formulation. In some embodiments, the amount of nitrapyrin-containing composition present in the nitrapyin-containing formulation is at least about 50%, about 60%, about 70%, about 80%, about 85%, about 90%, about 92%, about 95%, or at least about 98% by weight based on the total weight of the formulation.

In some embodiments, the amount of the corrosion inhibitor composition and the nitrapyrin-containing composition present in the noncorrosive nitrapyrin formulation can vary. For example, in some embodiments, the amount of corrosion inhibitor composition present in the noncorrosive nitrapyrin formulation ranges from about 0.1% to about 20%, from about 0.1% to about 18%, from about 0.1% to about 15%, from about 0.1% to about 12%, from about 0.1% to about 10%, from about 0.1% to about 7%, from about 0.1% to about 5%, from about 0.1% to about 4.5%, from about 0.1% to about 4%, from about 0.1% to about 3.5%, from about 0.1% to about 3%, from about 0.1% to about 2.5%, from about 0.1% to about 2%, from about 0.1% to about 1.5% from about 0.1% to about 1%, or from about 0.1% to about 0.5% by weight based on the total weight of the formulation. In some embodiments, the amount of corrosion inhibitor composition present in the noncorrosive nitrapyrin formulation is less than about 3%, about 2.9%, about 2.8%, about 2.7%, about 2.8%, about 2.7%, about 2.6%, about 2.5%, about 2.4%, about 2.3%, about 2.2%, about 2.1%, about 2.0%, about 1.9%, about 1.8%, about 1.7%, about 1.6%, about 1.5%, about 1.4%, about 1.3%, about 1.2%, about 1.1%, about 1.0%, about 0.9%, about 0.8%, about 0.7%, about 0.6%, about 0.5%, about 0.4%, about 0.3%, about 0.2%, about 0.1%, or less than 0.05% by weight based on the total weight of the formulation.

In some embodiments, the amount of the nitrapyrin-containing composition present in the noncorrosive nitrapyrin formulation ranges from about about 50% to about 99.9%, 60% to about 99.9%, 70% to about 99.9%, 80% to about 99.9%, from about 82% to about 99.9%, from about 85% to about 99.9%, from about 88% to about 99.9%, from about 90% to about 99.9%, from about 93% to about 99.9%, from about 95% to about 99.9%, from about 95.5% to about 99.9%, from about 96% to about 99.9%, from about 96.5% to about 99.9%, from about 97% to about 99.9%, from about 97.5% to about 99.9%, from about 98% to about 99.9%, from about 98.5 to about 99.9%, from about 99% to about 99.9%, from about 98.5% to about 99.9% by weight based on the total weight of the formulation. In some embodiments, the amount of nitrapyrin-containing composition present in the noncorrosive nitrapyrin formulation is at least about 50%, about 60%, about 70%, about 80%, about 85%, about 90%, about 95%, about 97%, 97.1%, 97.2%, 97.3%, 97.4%, 97.5%, 97.6%, 97.7%, 97.8%, 97.9%, 98%, 98.1%, 98.2%, 98.3%, 98.4%, 98.5%, 98.6%, 98.7%, 98.8%, 99%, 99.1%, 99.2%, 99.3%, 99.4%, 99.5%, 99.6%, 99.7%, 99.8%, 99.9% or at least 99.95% by weight based on the total weight of the formulation.

The amount of the nitrapyrin present in the noncorrosive nitrapyrin formulation ranges from about about 1% to about 99.9%, 10% to about 99.9%, 10% to about 80%, 10% to about 70%, from about 10% to about 60%, from about 10% to about 50%, from about 10% to about 40%, or from about 10% to about 30% by weight based on the total weight of the formulation

In some embodiments, the amount of corrosion inhibitor composition and nitrapyrin-containing composition present in the noncorrosive nitrapyrin formulation ranges from about 1:1000 to about 1000:1, 1:500 to about 500:1, 1:250 to about 250:1, from about 1:100 to about 100:1, from about 1:75 to about 75:1, from about 1:50 to about 50:1, from about 1:25 to about 25:1, from about 1:10 to about 10:1, from about 1:5 to about 5:1 ratio by weight of corrosion inhibitor composition: nitrapyrin-containing composition.

In some embodiments, the noncorrosive nitrapyrin formulation further comprises an organic solvent as described above. The amount of organic solvent in the noncorrosive nitrapyrin formulation can vary. In some embodiments, the organic solvent ranges from about 1% to about 90%, from about 10% to about 85%, from about 15% to about 80%, from about 20% to about 75%, from about 30% to about 70%, from about 35% to about 65%, from about 40% to about 60%, or from about 45% to about 55% by weight based on the total weight of the noncorrosive nitrapyrin formulation. In some embodiments, the organic solvent employed in the noncorrosive nitrapyrin formulation comprises at least one polar organic solvent.

In some embodiments, the corrosion inhibitor composition and the nitrapyrin-containing composition are completely miscible with each other. In other words, the corrosion inhibitor composition and the nitrapyrin-containing composition mix with one another to form a homogenous solution without any precipitates or oil formation. In some embodiments, the corrosion inhibitor composition and the nitrapyrin-containing composition are miscible with each other for up to about 1, 2, 3, 4, 5, 6, 7, 8, 9, 10, 11, 12, 13, 14, 15, 16, 17, 18, 19, 20, 21, 22, 23, or about 24 hours. In some embodiments, the corrosion inhibitor composition and the nitrapyrin-containing composition are miscible with each other for up to about 1, 2, 3, 4, 5, 6, 7, 8, 9, 10, 11, 12, 13, 14, 15, 16, 17, 18, 19, 20, 21, 22, 23, or about 24 days.

In some embodiments, the formulations disclosed herein exhibit a reduced corrosion behavior compared to nitrapyrin formulations that do not contain a corrosion inhibitor composition. In particular, the formulations disclosed herein exhibit a reduced corrosion behavior towards metal-based materials used in agricultural equipment. Such metal-based materials include, but are not limited to, aluminum, mild steel, carbon steel, iron, carbon steel, steel alloys, and a combination thereof.

In some embodiments, the disclosed noncorrosive nitrapyrin formulations exhibit reduced corrosion behavior compared to nitrapyrin formulated with other formulations. In some embodiments, noncorrosive nitrapyrin formulations exhibit a reduction in corrosion by at least about 5%, 10%, 20%, 30%, 40%, 50%, 60%, 70%, 80%, 90%, 95%, or at least 98% compared to nitrapyrin-containing formulations that do not contain nitrapyrin (e.g., N-Serve® and/or Instinct® II). In some embodiments, noncorrosive nitrapyrin formulations exhibit a reduction in corrosion of about 1% to about 100%, from about 50% to about 100%, from about 60% to about 100%, from about 70% to about 100%, from about 80% to about 100%, from about 90% to about 100%, from about 1% to about 70%, from about 10% to about 70%, from about 10% to about 60%, from about 20% to about 50%, from about 30% to about 50%, from about 40% to about 50%, from about 20% to about 80%, or from about 10% to about 90% compared to nitrapyrin-containing formulations that do not contain an corrosion inhibitor composition as disclosed herein.

### III. Agricultural Products

Any of the described noncorrosive nitrapyrin formulations and compositions thereof can be combined with one or more other ingredients, selected from the group consisting of fertilizer, agriculturally active compounds, seed, compounds having urcase inhibition activity, nitrification inhibition activity, one or more biocides (e.g., pesticides, herbicides, insecticides, fungicides, and/or miticides), and the like.

In some embodiments, the described noncorrosive nitrapyrin formulations and compositions thereof may be mixed with the fertilizer products, applied as a surface coating to the fertilizer products, or otherwise thoroughly mixed with the fertilizer products. In some embodiments, in such combined fertilizer/noncorrosive nitrapyrin formulation compositions, the fertilizer is in the form of particles having an average diameter of from about powder size (less than about 0.001 cm) to about 10 mm, more preferably from about 0.1 mm to about 5 mm, and still more preferably from about 0.15 mm to about 3 mm. The nitrapyrin can be present in such combined products at a level of about 0.001 g to about 20 g per 100 g fertilizer, about 0.01 g to 7 g per 100 g fertilizer, about 0.08 g to about 5 g per 100 g fertilizer, or about 0.09 g to about 2 g per 100 g fertilizer. In the case of the combined fertilizer/noncorrosive nitrapyrin formulation products, the combined product can be applied at a level so that the amount of nitrapyrin complex applied is about 10-150 g per acre of soil, about 30-125 g per acre of soil, or about 40-120 g per acre of soil. The combined products can likewise be applied as liquid dispersions or as dry granulated products, at the discretion of the user. When noncorrosive nitrapyrin formulations are used as a coating, the noncorrosive nitrapyrin formulations can comprise between about 0.005% and about 15% by weight of the coated fertilizer product, about 0.01% and about 10% by weight of the coated fertilizer product, about 0.05% and about 2% by weight of the coated fertilizer product or about 0.5% and about 1% by weight of the coated fertilizer product.

### A. Fertilizers

In some embodiments, the agricultural product is a fertilizer. The fertilizer can be a solid fertilizer, such as, but not limited to, a granular fertilizer, and the noncorrosive nitrapyrin formulation can be applied to the fertilizer as a liquid dispersion. The fertilizer can be in liquid form, and the noncorrosive nitrapyrin formulation can be mixed with the liquid fertilizer. The fertilizers can be selected from the group consisting of starter fertilizers, phosphate-based fertilizers, fertilizers containing nitrogen, fertilizers containing phosphorus, fertilizers containing potassium, fertilizers containing calcium, fertilizers containing magnesium, fertilizers containing boron, fertilizers containing chlorine, fertilizers containing zinc, fertilizers containing manganese, fertilizers containing copper, fertilizers containing urea and ammonium nitrite and/or fertilizers containing molybdenum materials. In some embodiments, the fertilizer is or contains urea and/or ammonia, including anhydrous ammonia fertilizer. In some embodiments, the fertilizer comprises plant-available nitrogen, phosphorous, potassium, sulfur, calcium, magnesium, or micronutrients. In some embodiments, the fertilizer is solid, granular, a fluid suspension, a gas, or a solubilized fertilizer. In some embodiments, the fertilizer comprises a micronutrient. A micronutrient is an essential element required by a plant in small quantities. In some embodiments, the fertilizer comprises a metal ion selected from the group consisting of: Fe, Mn, Mg, Zn, Cu, Ni, Co, Mo, V, and Ca. In some embodiments, the fertilizer comprises gypsum, Kieserite Group member, potassium product, potassium magnesium sulfate, elemental sulfur, or potassium magnesium sulfate. Such fertilizers may be granular, liquid, gaseous, or mixtures (e.g., suspensions of solid fertilizer particles in liquid material).

In some embodiments, the noncorrosive nitrapyrin formulation is combined with any suitable liquid or dry fertilizer for application to fields and/or crops.

The described noncorrosive nitrapyrin formulation, or compositions thereof, can be applied with the application of a fertilizer. The noncorrosive nitrapyrin formulation can be applied prior to, subsequent to, or simultaneously with the application of fertilizers.

### B. Seed

Some embodiments describe agricultural seeds coated with one or more of the described noncorrosive nitrapyrin formulations. The noncorrosive nitrapyrin formulations can be present in the seed product at a level of from about 0.001 to about 10%, about 0.004% to about 2%, about 0.01% to about 1%, or from about 0.1% to about 1% by weight (or no more than about 10%, about 9%, about 8%, about 7% about 6%, about 5%, about 4%, about 3%, about 2%, about 1%, about 0.5%, about 0.1%, about 0.01% or no more than 0.001%), based upon the total weight of the coated seed product. A seed can be, but is not limited to, wheat, barley, oat, triticale, rye, rice, maize, soya bean, cotton, or oilseed rape.

### C. Other

In some embodiments are described urease-inhibiting compounds, nitrification-inhibiting compounds, biocides (e.g., pesticides, herbicides, insecticides, fungicides, and/or miticides) in combination with one or more of the described noncorrosive nitrapyrin formulations. As used herein, “pesticide” refers to any agent with pesticidal activity (e.g., herbicides, insecticides, and fungicides) and is preferably selected from the group consisting of insecticides, herbicides, and mixtures thereof, but normally excluding materials which assertedly have plant-fertilizing effect, for example, sodium borate and zinc compounds such as zinc oxide, zinc sulfate, and zinc chloride. For an unlimited list of pesticides, see “Farm Chemicals Handbook 2000, 2004” (Meister Publishing Co, Willoughby, OH), which is hereby incorporated by reference in its entirety.

Exemplary herbicides include, but are not limited to, acetochlor, alachlor, aminopyralid, atrazine, benoxacor, bromoxynil, carfentrazone, chlorsulfuron, clodinafop, clopyralid, dicamba, diclofop-methyl, dimethenamid, fenoxaprop, flucarbazone, flufenacet, flumetsulam, flumiclorac, fluroxypyr, glufosinate-ammonium, glyphosate, halosulfuron-methyl, imazamethabenz, imazamox, imazapyr, imazaquin, imazethapyr, isoxaflutole, quinclorac, MCPA, MCP amine, MCP ester, mefenoxam, mesotrione, metolachlor, s-metolachlor, metribuzin, metsulfuron methyl, nicosulfuron, paraquat, pendimethalin, picloram, primisulfuron, propoxycarbazone, prosulfuron, pyraflufen cthyl, rimsulfuron, simazinc, sulfosulfuron, thifensulfuron, topramezone, tralkoxydim, triallate, triasulfuron, tribenuron, triclopyr, trifluralin, 2,4-D, 2,4-D amine, 2,4-D ester, and the like.

Exemplary insecticides include, but are not limited to, 1,2 dichloropropane, 1,3 dichloropropene, abamectin, acephate, acequinocyl, acetamiprid, accthion, acetoprole, acrinathrin, acrylonitrile, alanycarb, aldicarb, aldoxycarb, aldrin, allethrin, allosamidin, allyxycarb, alpha cypermethrin, alpha ecdysone, amidithion, amidoflumet, aminocarb, amiton, amitraz, anabasine, arsenous oxide, athidathion, azadirachtin, azamethiphos, azinphos cthyl, azinphos methyl, azobenzene, azocyclotin, azothoate, barium hexafluorosilicate, barthrin, benclothiaz, bendiocarb, benfuracarb, benoxafos, bensultap, benzoximate, benzyl benzoate, beta cyfluthrin, beta cypermethrin, bifenazate, bifenthrin, binapacryl, bioallethrin, bioethanomethrin, biopermethrin, bistrifluron, borax, boric acid, bromfenvinfos, bromo DDT, bromocyclen, bromophos, bromophos cthyl, bromopropylate, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, chinomethionat, chlorantraniliprole, chlorbenside, chlorbicyclen, chlordane, chlordecone, chlordimeform, chlorethoxyfos, chlorfenapyr, chlorfenethol, chlorfenson, chlorfensulphide, chlorfenvinphos, chlorfluazuron, chlormephos, chlorobenzilate, chloroform, chloromebuform, chloromethiuron, chloropicrin, chloropropylate, chlorphoxim, chlorprazophos, chlorpyrifos, chlorpyrifos methyl, chlorthiophos, chromafenozide, cinerin I, cinerin II, cismethrin, clocthocarb, clofentezine, closantel, clothianidin, copper acetoarsenite, copper arsenate, copper naphthenate, copper oleate, coumaphos, coumithoate, crotamiton, crotoxyphos, cruentaren A & B, crufomate, cryolite, cyanofenphos, cyanophos, cyanthoate, cyclethrin, cycloprothrin, cyenopyrafen, cyflumetofen, cyfluthrin, cyhalothrin, cyhexatin, cypermethrin, cyphenothrin, cyromazinc, cythioate, d-limonene, dazomet, DBCP, DCIP, DDT, decarbofuran, deltamethrin, demephion, demephion O, demephion S, demeton, demeton methyl, demeton O, demeton O methyl, demeton S, demeton S methyl, demeton S methylsulphon, diafenthiuron, dialifos, diamidafos, diazinon, dicapthon, dichlofenthion, dichlofluanid, dichlorvos, dicofol, dicresyl, dicrotophos, dicyclanil, dieldrin, dienochlor, diflovidazin, diflubenzuron, dilor, dimefluthrin, dimefox, dimetan, dimethoate, dimethrin, dimethylvinphos, dimetilan, dinex, dinobuton, dinocap, dinocap 4, dinocap 6, dinocton, dinopenton, dinoprop, dinosam, dinosulfon, dinotefuran, dinoterbon, diofenolan, dioxabenzofos, dioxacarb, dioxathion, diphenyl sulfone, disulfiram, disulfoton, dithicrofos, DNOC, dofenapyn, doramectin, ecdysterone, emamectin, EMPC, empenthrin, endosulfan, endothion, endrin, EPN, epofenonane, eprinomectin, esfenvalerate, ctaphos, cthiofencarb, cthion, ethiprole, ethoate methyl, ethoprophos, ethyl DDD, ethyl formate, ethylene dibromide, ethylene dichloride, ethylene oxide, ctofenprox, ctoxazole, ctrimfos, EXD, famphur, fenamiphos, fenazaflor, fenazaquin, fenbutatin oxide, fenchlorphos, fenethacarb, fenfluthrin, fenitrothion, fenobucarb, fenothiocarb, fenoxacrim, fenoxycarb, fenpirithrin, fenpropathrin, fenpyroximate, fenson, fensulfothion, fenthion, fenthion ethyl, fentrifanil, fenvalerate, fipronil, flonicamid, fluacrypyrim, fluazuron, flubendiamide, flubenzimine, flucofuron, flucycloxuron, flucythrinate, fluenetil, flufenerim, flufenoxuron, flufenprox, flumethrin, fluorbenside, fluvalinate, fonofos, formetanate, formothion, formparanate, fosmethilan, fospirate, fosthiazate, fosthictan, fosthictan, furathiocarb, furethrin, furfural, gamma cyhalothrin, gamma HCH, halfenprox, halofenozide, HCH, HEOD, heptachlor, heptenophos, heterophos, hexaflumuron, hexythiazox, HHDN, hydramethylnon, hydrogen cyanide, hydroprene, hyquincarb, imicyafos, imidacloprid, imiprothrin, indoxacarb, iodomethane, IPSP, isamidofos, isazofos, isobenzan, isocarbophos, isodrin, isofenphos, isoprocarb, isoprothiolane, isothioate, isoxathion, ivermectin jasmolin I, jasmolin II, jodfenphos, juvenile hormone I, juvenile hormone II, juvenile hormone III, kelevan, kinoprene, lambda cyhalothrin, lead arsenate, lepimectin, leptophos, lindane, lirimfos, lufcnuron, lythidathion, malathion, malonoben, mazidox, mecarbam, mecarphon, menazon, mephosfolan, mercurous chloride, mesulfen, mesulfenfos, metaflumizone, metam, methacrifos, methamidophos, methidathion, methiocarb, methocrotophos, methomyl, methoprene, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, MNAF, monocrotophos, morphothion, moxidectin, naftalofos, naled, naphthalene, nicotine, nifluridide, nikkomycins, nitenpyram, nithiazine, nitrilacarb, novaluron, noviflumuron, omethoate, oxamyl, oxydemeton methyl, oxydeprofos, oxydisulfoton, paradichlorobenzene, parathion, parathion methyl, penfluron, pentachlorophenol, permethrin, phenkapton, phenothrin, phenthoate, phorate, phosalone, phosfolan, phosmet, phosnichlor, phosphamidon, phosphine, phosphocarb, phoxim, phoxim methyl, pirimetaphos, pirimicarb, pirimiphos ethyl, pirimiphos methyl, potassium arsenite, potassium thiocyanate, p,p′-DDT, prallethrin, precocene I, precocene II, precocene III, primidophos, proclonol, profenofos, profluthrin, promacyl, promecarb, propaphos, propargite, propctamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen, quassia, quinalphos, quinalphos, quinalphos methyl, quinothion, rafoxanide, resmethrin, rotenone, ryania, sabadilla, schradan, selamectin, silafluofen, sodium arsenite, sodium fluoride, sodium hexafluorosilicate, sodium thiocyanate, sophamide, spinctoram, spinosad, spirodiclofen, spiromesifen, spirotetramat, sulcofuron, sulfiram, sulfluramid, sulfotep, sulfur, sulfuryl fluoride, sulprofos, tau fluvalinate, tazimcarb, TDE, tebufenozide, tebufenpyrad, tebupirimfos, teflubenzuron, tefluthrin, temephos, TEPP, terallethrin, terbufos, tetrachlorocthanc, tetrachlorvinphos, tetradifon, tetramethrin, tetranactin, tetrasul, theta cypermethrin, thiacloprid, thiamethoxam, thicrofos, thiocarboxime, thiocyclam, thiodicarb, thiofanox, thiometon, thionazin, thioquinox, thiosultap, thuringiensin, tolfenpyrad, tralomethrin, transfluthrin, transpermethrin, triarathene, triazamate, triazophos, trichlorfon, trichlormetaphos 3, trichloronat, trifenofos, triflumuron, trimethacarb, triprene, vamidothion, vamidothion, vaniliprole, XMC, xylylcarb, zeta cypermethrin and zolaprofos.

Exemplary fungicides include, but are not limited to, acibenzolar, acylamino acid fungicides, acypetacs, aldimorph, aliphatic nitrogen fungicides, allyl alcohol, amide fungicides, ampropylfos, anilazine, anilide fungicides, antibiotic fungicides, aromatic fungicides, aureofungin, azaconazole, azithiram, azoxystrobin, barium polysulfide, benalaxyl, benalaxyl-M, benodanil, benomyl, benquinox, bentaluron, benthiavalicarb, benzalkonium chloride, benzamacril, benzamide fungicides, benzamorf, benzanilide fungicides, benzimidazole fungicides, benzimidazole precursor fungicides, benzimidazolylcarbamate fungicides, benzohydroxamic acid, benzothiazole fungicides, bethoxazin, binapacryl, biphenyl, bitertanol, bithionol, bixafen, blasticidin-S, Bordeaux mixture, boric acid, boscalid, bridged diphenyl fungicides, bromuconazole, bupirimate, Burgundy mixture, buthiobate, sec-butylaminc, calcium polysulfide, captafol, captan, carbamate fungicides, carbamorph, carbanilate fungicides, carbendazim, carboxin, carpropamid, carvone, Cheshunt mixture, chinomethionat, chlobenthiazone, chloraniformethan, chloranil, chlorfenazole, chlorodinitronaphthalene, chloroform, chloroneb, chloropicrin, chlorothalonil, chlorquinox, chlozolinate, ciclopirox, climbazole, clotrimazole, conazole fungicides, conazole fungicides (imidazoles), conazole fungicides (triazoles), copper(II) acetate, copper(II) carbonate, basic, copper fungicides, copper hydroxide, copper naphthenate, copper oleate, copper oxychloride, copper(II) sulfate, copper sulfate, basic, copper zinc chromate, cresol, cufraneb, cuprobam, cuprous oxide, cyazofamid, cyclafuramid, cyclic dithiocarbamate fungicides, cycloheximide, cyflufenamid, cymoxanil, cypendazole, cyproconazole, cyprodinil, dazomet, DBCP, debacarb, decafentin, dehydroacetic acid, dicarboximide fungicides, dichlofluanid, dichlone, dichlorophen, dichlorophenyl, dichlozoline, diclobutrazol, diclocymet, diclomezine, dicloran, dicthofencarb, diethyl pyrocarbonate, difenoconazole, diflumctorim, dimethirimol, dimethomorph, dimoxystrobin, diniconazole, diniconazole-M, dinitrophenol fungicides, dinobuton, dinocap, dinocap-4, dinocap-6, dinocton, dinopenton, dinosulfon, dinoterbon, diphenylamine, dipyrithione, disulfiram, ditalimfos, dithianon, dithiocarbamate fungicides, DNOC, dodemorph, dodicin, dodine, donatodine, drazoxolon, edifenphos, epoxiconazole, ctaconazole, etem, cthaboxam, ethirimol, ethoxyquin, cthylene oxide, ethylmercury 2,3-dihydroxypropyl mercaptide, ethylmercury acetate, ethylmercury bromide, ethylmercury chloride, cthylmercury phosphate, etridiazole, famoxadone, fenamidone, fenaminosulf, fenapanil, fenarimol, fenbuconazole, fenfuram, fenhexamid, fenitropan, fenoxanil, fenpiclonil, fenpropidin, fenpropimorph, fentin, ferbam, ferimzone, fluazinam, fluconazole, fludioxonil, flumetover, flumorph, fluopicolide, fluoroimide, fluotrimazole, fluoxastrobin, fluquinconazole, flusilazole, flusulfamide, flutolanil, flutriafol, fluxapyroxad, folpet, formaldehyde, fosetyl, fuberidazole, furalaxyl, furametpyr, furamide fungicides, furanilide fungicides, furcarbanil, furconazole, furconazole-cis, furfural, furmecyclox, furophanatc, glyodin, griscofulvin, guazatine, halacrinate, hexachlorobenzene, hexachlorobutadiene, hexachlorophene, hexaconazole, hexylthiofos, hydrargaphen, hymexazol, imazalil, imibenconazole, imidazole fungicides, iminoctadine, inorganic fungicides, inorganic mercury fungicides, iodomethane, ipconazole, iprobenfos, iprodione, iprovalicarb, isopropyl alcohol, isoprothiolane, isovaledione, isopyrazam, kasugamycin, ketoconazole, kresoxim-methyl, lime sulfur (lime sulphur), mancopper, mancozeb, maneb, mebenil, mccarbinzid, mepanipyrim, mepronil, mercuric chloride (obsolete), mercuric oxide (obsolete), mercurous chloride (obsolete), metalaxyl, metalaxyl-M (a.k.a. Mefenoxam), metam, metazoxolon, metconazole, methasulfocarb, methfuroxam, methyl bromide, methyl isothiocyanate, methylmercury benzoate, methylmercury dicyandiamide, methylmercury pentachlorophenoxide, metiram, metominostrobin, metrafenone, metsulfovax, milneb, morpholine fungicides, myclobutanil, myclozolin, N-(ethylmercury)-p-toluenesulfonanilide, nabam, natamycin, nystatin, β-nitrostyrene, nitrothal-isopropyl, nuarimol, OCH, octhilinone, ofurace, oprodione, organomercury fungicides, organophosphorus fungicides, organotin fungicides (obsolete), orthophenyl phenol, orysastrobin, oxadixyl, oxathiin fungicides, oxazole fungicides, oxine copper, oxpoconazole, oxycarboxin, pefurazoate, penconazole, pencycuron, pentachlorophenol, penthiopyrad, phenylmercuriurea, phenylmercury acetate, phenylmercury chloride, phenylmercury derivative of pyrocatechol, phenylmercury nitrate, phenylmercury salicylate, phenylsulfamide fungicides, phosdiphen, phosphite, phthalide, phthalimide fungicides, picoxystrobin, piperalin, polycarbamate, polymeric dithiocarbamate fungicides, polyoxins, polyoxorim, polysulfide fungicides, potassium azide, potassium polysulfide, potassium thiocyanate, probenazole, prochloraz, procymidone, propamocarb, propiconazole, propineb, proquinazid, prothiocarb, prothioconazole, pyracarbolid, pyraclostrobin, pyrazole fungicides, pyrazophos, pyridine fungicides, pyridinitril, pyrifenox, pyrimethanil, pyrimidine fungicides, pyroquilon, pyroxychlor, pyroxyfur, pyrrole fungicides, quinacetol, quinazamid, quinconazole, quinoline fungicides, quinomethionate, quinone fungicides, quinoxaline fungicides, quinoxyfen, quintozene, rabenzazole, salicylanilide, silthiofam, silver, simeconazole, sodium azide, sodium bicarbonate[2][3], sodium orthophenylphenoxide, sodium pentachlorophenoxide, sodium polysulfide, spiroxamine, streptomycin, strobilurin fungicides, sulfonanilide fungicides, sulfur, sulfuryl fluoride, sultropen, TCMTB, tebuconazole, tecloftalam, tecnazene, tecoram, tetraconazole, thiabendazole, thiadifluor, thiazole fungicides, thicyofen, thifluzamide, thymol, triforine, thiocarbamate fungicides, thiochlorfenphim, thiomersal, thiophanate, thiophanate-methyl, thiophene fungicides, thioquinox, thiram, tiadinil, tioxymid, tivedo, tolclofos-methyl, tolnaftate, tolylfluanid, tolylmercury acetate, triadimefon, triadimenol, triamiphos, triarimol, triazbutil, triazine fungicides, triazole fungicides, triazoxide, tributyltin oxide, trichlamide, tricyclazole, tridemorph, trifloxystrobin, triflumizole, triforine, triticonazole, unclassified fungicides, undecylenic acid, uniconazole, uniconazole-P, urea fungicides, validamycin, valinamide fungicides, vinclozolin, voriconazole, zarilamid, zinc naphthenate, zineb, ziram, and/or zoxamide.

In some embodiments, the composition of the presently disclosed subject matter is a pesticide/noncorrosive nitrapyrin formulation-containing composition comprising a pesticide and a noncorrosive nitrapyrin formulation. In some embodiments, the pesticide is an herbicide, insecticide, or a combination thereof.

In some embodiments, the composition of the presently disclosed subject matter is a fungicide/noncorrosive nitrapyrin formulation-containing composition comprising a fungicide and a noncorrosive nitrapyrin formulation.

The amount of noncorrosive nitrapyrin formulation in the pesticide/noncorrosive nitrapyrin formulation-containing composition and/or fungicide/noncorrosive nitrapyrin formulation-containing composition can vary. In some embodiments, the amount of noncorrosive nitrapyrin formulation is present at a level of from about 0.05-10% by weight (more preferably from about 0.1%- 4% by weight, and most preferably from about 0.2-2% by weight) based upon the total weight of the pesticide/noncorrosive nitrapyrin formulation containing composition or fungicide/noncorrosive nitrapyrin formulation-containing composition taken as 100% by weight.

Exemplary classes of miticides include, but are not limited to, botanical acaricides, bridged diphenyl acaricides, carbamate acaricides, oxime carbamate acaricides, carbazate acaricides, dinitrophenol acaricides, formamidine acaricides, isoxaline acaricides, macrocyclic lactone acaricides, avermectin acaricides, milbemycin acaricides, milbemycin acaricides, mite growth regulators, organochlorine acaricides, organophosphate acaricides, organothiophosphate acaricides, phosphonate acaricides, phosphoarmidothiolate acaricides, organitin acaricides, phenylsulfonamide acaricides, pyrazolecarboxamide acaricides, pyrethroid ether acaricides, quaternary ammonium acaricides, pyrethroid ester acaricides, pyrrole acaricides, quinoxaline acaricides, methoxyacrylate strobilurin acaricides, teronic acid acaricides, thiasolidine acaricides, thiocarbamate acaricides, thiourca acaricides, and unclassified acaricides. Examples of miticides for these classes include, but are not limited to, botanical acaricides—carvacrol, sanguinarine; bridged diphenyl acaricides—azobenzene, benzoximate, benzyl, benzoate, bromopropylate, chlorbenside, chlorfenethol, chlorfenson, chlorfensulphide, chlorobenzilate, chloropropylate, cyflumetofen, DDT, dicofol, diphenyl, sulfone, dofenapyn, fenson, fentrifanil, fluorbenside, genit, hexachlorophene, phenproxide, proclonol, tetradifon, tetrasul; carbamate acaricides—benomyl, carbanolate, carbaryl, carbofuran, methiocarb, metolcarb, promacyl, propoxur; oxime carbamate acaricides—aldicarb, butocarboxim, oxamyl, thiocarboxime, thiofanox; carbazate acaricides—bifenazate; dinitrophenol acaricides—binapacryl, dinex, dinobuton, dinocap, dinocap-4, dinocap-6, dinocton, dinopenton, dinosulfon, dinoterbon, DNOC; formamidine acaricides—amitraz, chlordimeform, chloromebuform, formetanate, formparanate, medimeform, semiamitraz; isoxazoline acaricides—afoxolaner, fluralaner, lotilaner, sarolaner; macrocyclic lactone acaricides—tetranactin; avermectin acaricides—abamectin, doramectin, eprinomectin, ivermectin, selamectin; milbemycin acaricides-milbemectin, milbemycin, oxime, moxidectin; mite growth regulators—clofentezine, cyromazine, diflovidazin, dofenapyn, fluazuron, flubenzimine, flucycloxuron, flufenoxuron, hexythiazox; organochlorine acaricides—bromociclen, camphechlor, DDT, dienochlor, endosulfan, lindane; organophosphate acaricides—chlorfenvinphos, crotoxyphos, dichlorvos, heptenophos, mevinphos, monocrotophos, naled, TEPP, tetrachlorvinphos; organothiophosphate acaricides—amidithion, amiton, azinphos-ethyl, azinphos-methyl, azothoate, benoxafos, bromophos, bromophos-ethyl, carbophenothion, chlorpyrifos, chlorthiophos, coumaphos, cyanthoate, demeton, demeton-O, demeton-S, demeton-methyl, demeton-O-methyl, demeton-S-methyl, demeton-S-methylsulphon, dialifos, diazinon, dimethoate, dioxathion, disulfoton, endothion, cthion, ethoate-methyl, formothion, malathion, mecarbam, methacrifos, omethoate, oxydeprofos, oxydisulfoton, parathion, phenkapton, phorate, phosalone, phosmet, phostin, phoxim, pirimiphos-methyl, prothidathion, prothoate, pyrimitate, quinalphos, quintiofos, sophamide, sulfotep, thiometon, triazophos, trifenofos, vamidothion; phosphonate acaricides-trichlorfon; phosphoramidothioate acaricides—isocarbophos, methamidophos, propetamphos; phosphorodiamide acaricides—dimefox, mipafox, schradan; organotin acaricides—azocyclotin, cyhexatin, fenbutatin, oxide, phostin; phenylsulfamide acaricides—dichlofluanid; phthalimide acaricides—dialifos, phosmet; pyrazole acaricides_13 cyenopyrafen, fenpyroximate; phenylpyrazole acaricides—acetoprole, fipronil, vaniliprole; pyrazolecarboxamide acaricides—pyflubumide, tebufenpyrad; pyrethroid ester acaricides—acrinathrin, bifenthrin, brofluthrinate, cyhalothrin, cypermethrin, alpha-cypermethrin, fenpropathrin, fenvalerate, flucythrinate, flumethrin, fluvalinate, tau-fluvalinate, permethrin; pyrethroid ether acaricides—halfenprox; pyrimidinamine acaricides—pyrimidifen; pyrrole acaricides—chlorfenapyr; quaternary ammonium acaricides—sanguinarine; quinoxaline acaricides—chinomethionat, thioquinox; methoxyacrylate strobilurin acaricides—bifujunzhi, fluacrypyrim, flufenoxystrobin, pyriminostrobin; sulfite ester acaricides—aramite, propargite; tetronic acid acaricides—spirodiclofen; tetrazine acaricides, clofentezine, diflovidazin; thiazolidine acaricides—flubenzimine, hexythiazox; thiocarbamate acaricides—fenothiocarb; thiourea acaricides—chloromethiuron, diafenthiuron; unclassified acaricides—acequinocyl, acynonapyr, amidoflumet, arsenous, oxide, clenpirin, closantel, crotamiton, cycloprate, cymiazole, disulfiram, ctoxazole, fenazaflor, fenazaquin, fluenetil, mesulfen, MNAF, nifluridide, nikkomycins, pyridaben, sulfiram, sulfluramid, sulfur, thuringiensin, triarathene.

In some embodiments, a miticide can also be selected from abamectin, acephate, acequinocyl, acetamiprid, aldicarb, allethrin, aluminum phosphide, aminocarb, amitraz, azadiractin, azinphos-ethyl, azinphos-m cthyl, Bacillus thuringiensis, bendiocarb, betacyfluthrin, bifenazate, bifenthrin, bomyl, buprofezin, calcium cyanide, carbaryl, carbofuran, carbon disulfide, carbon tetrachloride, chlorfenvinphos, chlorobenzilate, chloropicrin, chlorpyrifos, clofentezine, chlorfenapyr, clothianidin, coumaphos, crotoxyphos, crotoxyphos+dichlorvos, cryolite, cyfluthrin, cyromazine, cypermethrin, deet, deltamethrin, demeton, diazinon, dichlofenthion, dichloropropene, dichlorvos, dicofol, dicrotophos, dieldrin, dienochlor, diflubenzuron, dikar (fungicide+miticide), dimethoate, dinocap, dinotefuran, dioxathion, disulfoton, emamectin benzoate, endosulfan, endrin, esfenvalerate, cthion, ethoprop, ethylene dibromide, ethylene dichloride, etoxazole, famphur, fenitrothion, fenoxycarb, fenpropathrin, fenpyroximate, fensulfothion, fenthion, fenvalerate, flonicamid, flucythrinate, fluvalinate, fonofos, formetanate hydrochloride, gamma-cyhalothrin, halofenozide, hexakis, hexythiazox, hydramethylnon, hydrated lime, indoxacarb, imidacloprid, kerosene, kinoprene, lambda-cyhalothrin, lead arsenate, lindane, malathion, mephosfolan, metaldehyde, metam-sodium, methamidophos, methidathion, methiocarb, methomyl, rotenone, s-methoprene, methoxychlor, methoxyfenozide, methyl bromide, methyl parathion, mevinphos, mexacarbate, Milky Spore Disease, naled, naphthalene, nicotine sulfate, novaluron, oxamyl, oxydemeton-methyl, oxythioquinox, para-dichlorobenzene, parathion, PCP, permethrin, petroleum oils, phorate, phosalone, phosfolan, phosmet, phosphamidon, phoxim, piperonyl butoxide, pirimicarb, pirimiphos-methyl, profenofos, propargite, propetamphos, propoxur, pymetrozine, pyrethroids—synthetic: see allethrin, permethrin, fenvalerate, resmethrin, pyrethrum, pyridaben, pyriproxyfen, resmethrinmethoprene, soap, pesticidal, sodium fluoride, spinosad, spiromesifen, sulfotep, sulprofos, temephos, terbufos, tetrachlorvinphos, tetrachlorvinphos+dichlorvos, tetradifon, thiamethoxam, thiodicarb, toxaphene, tralomethrin, trimethacarb, and tebufenozide.

### IV. Methods

In some embodiments, the noncorrosive nitrapyrin formulations are formulated in ways to make their use convenient in the context of productive agriculture. The noncorrosive nitrapyrin formulations used in these methods include nitrapyrin-containing compositions as described above. The noncorrosive nitrapyrin formulations can be used in methods such as:
A. Methods of Improving Plant Growth and/or Fertilizing Soil
B. Methods of Inhibiting Nitrification or Ammonia Release or Evolution
C. Methods of Improving Soil Conditions
D. Methods of Preparing Noncorrosive Nitrapyrin Formulations
E. Methods of Reducing Corrosion of Metal-Based Materials

A. Methods for improving plant growth comprise contacting a noncorrosive nitrapyrin formulation or an agricultural composition thereof as disclosed herein with soil. In some embodiments, the noncorrosive nitrapyrin formulation or agricultural composition is applied to the soil prior to emergence of a planted crop. In some embodiments, the noncorrosive nitrapyrin formulation is applied to the soil adjacent to the plant and/or at the base of the plant and/or in the root zone of the plant.

Methods for improving plant growth can also be achieved by applying a noncorrosive nitrapyrin formulation as a seed coating to a seed in the form of a liquid dispersion, which upon drying forms a dry residue. In these embodiments, seed coating provides the noncorrosive nitrapyrin formulation in close proximity to the seed when planted so that the nitrapyrin can exert its beneficial effects in the environment where it is most needed. That is, noncorrosive nitrapyrin formulation provides an environment conducive to enhanced plant growth in the area where the effects can be localized around the desired plant. In the case of seeds, the coating containing the noncorrosive nitrapyrin formulation provides an enhanced opportunity for seed germination, subsequent plant growth, and an increase in plant nutrient availability.

B. Methods for inhibiting/reducing nitrification or ammonia release or evolution in an affected area comprises applying a noncorrosive nitrapyrin formulation or composition thereof to the affected area. The affected area may be soil adjacent to a plant, a field, a pasture, a livestock or poultry confinement facility, pet litter, a manure collection zone, upright walls forming an enclosure, or a roof substantially covering the area, and in such cases the noncorrosive nitrapyrin formulation may be applied directly to the manure in the collection zone. The noncorrosive nitrapyrin formulation is preferably applied at a level from about 0.005-3 gallons per ton of manure, in neat form or in the form of an aqueous dispersion having a pH from about 1-5.

C. Methods for improving soil conditions selected from the group consisting of nitrification processes, urease activities, and combinations thereof, comprising the step of applying to soil an effective amount of a described noncorrosive nitrapyrin formulation or composition thereof. In some embodiments, the noncorrosive nitrapyrin formulation is mixed with an ammoniacal solid, liquid, or gaseous fertilizer, and especially solid fertilizers; in the latter case, the noncorrosive nitrapyrin formulation is applied to the surface of the fertilizer as an aqueous dispersion followed by drying, so that nitrapyrin-organic acid ionic mixture is present on the solid fertilizer as a dried residue. The noncorrosive nitrapyrin formulation is generally applied at a level of from about 0.01-10% by weight, based upon the total weight of the noncorrosive nitrapyrin formulation/fertilizer product taken as 100% by weight. Where the fertilizer is an aqueous liquid fertilizer, the noncorrosive nitrapyrin formulation is added thereto with mixing. The noncorrosive nitrapyrin formulation is in neat form or is in aqueous dispersion and has a pH of up to about 3.

D. Methods of preparing a noncorrosive nitrapyrin formulation comprises contacting a nitrapyrin-containing composition with a corrosion inhibitor composition. The nitrapyrin-containing composition is neat or can be prepared by mixing a first organic solvent with nitrapyrin prior to the contacting step with the corrosion inhibitor composition. The method optionally further comprises the addition of a second organic solvent, which is added either before or after the contacting step of the two compositions. In some embodiments, additives such as surface active agents, antifoam agents, emulsifier, and/or dispersants are added after the contacting step. For embodiments where no organic solvent is required, the corrosion inhibitor composition is contacted directly with the nitrapyrin-containing composition to form the noncorrosive nitrapyrin formulation.

E. Methods of reducing corrosion of metal-based materials used in agricultural equipment comprising: obtainining a noncorrosive nitrapyrin formulation or a corrosion inhibitor formulation as disclosed herein; and contacting a metal surface with the non-corrosive nitrapyrian formulation or corrosion inhibitor formulation for a period of time. In some embodiments, the metal surface is a portion of an agricultural equipment. In some embodiments, the metal surface contains aluminum, mild steel, carbon steel, iron, carbon steel, steel alloys, or a combination thereof. In such methods, the amount of corrosion of the metal-based material is less than the amount of corrosion of a metal-based material that has been in contract with a nitrapyrin-containing composition or corrosion inhibitor formulation not containing a corrosion inhibitor composition as disclosed herein. In some embodiments, the noncorrosive nitrapyrin formulation or corrosion inhibitor formulation inhibits corrosion of a metal-based material by at least 5%, 10%, 15%, 20%, 25%, 30%, 35%, 40%, 45%, 50%, 55%, 60%, 65%, 70%, 75%, 80%, 85%, 90%, 95%, 98%, or at least 99% compared to nitrapyrin-containing formulations or corrosion inhibitor formulations that do not contain a corrosion inhibitor composition as disclosed herein. In some embodiments, the noncorrosive nitrapyrin formulation or corrosion inhibitor formulation inhibits corrosion of a metal-based material in an amount of from about 20% to about 99%, from about 30% to about 99%, from about 50% to about 99%, from about 60% to about 99%, from about 75% to about 99%, from about 85% to about 99%, or from about 90% to about 99% compared to nitrapyrin-containing formulations or corrosion inhibitor formulations that do not contain a corrosion inhibitor composition as disclosed herein. In some embodiments, the obtained noncorrosive nitrapyrin formulation is already pre-made, i.e., is a noncorrosive nitrapyrin formulation as disclosed herein. In some embodiments, the obtained noncorrosive nitrapyrin formulation is made by adding the disclosed corrosion inhibitor composition to a nitrapyrin containing composition as disclosed herein.

In some embodiments, the time between the obtaining step and the contacting step can vary. In some embodiments, the obtaining step and the contacting step are carried out within about 24 hours, about 20 hours, about 15 hours, about 10 hours, about 5 hours, about 3 hours, or about 1 hour.

In some embodiments, the contact time between the noncorrosive formulation or corrosion inhibitor formulation and the surface of the metal-based material varies. In some embodiments, the contact time between the noncorrosive formulation or corrosion inhiiotr formulation and the surface ranges from about 1 minute to about 24 h, from about about 1 hour to about 24 h, from about 2 hours to about 22 hours, from about 3 hours to about 20 hours, from about 5 hours to about 15, from about 7 hours to about 12 hours. In some embodiments, the contact time is less than about 24 hours, from about 1 hour to about 24 hours, from about 3 hours to about 21 hours, from about 6 hours to about 18 hours, from about 9 hours to about 21 hours, from about 9 hours to about 24 hours, from about 10 hours to about 24 hours, or from about 14 hours to about 24 hours. In some embodiments, the contact time is less than 1 hour from about 1 min to about 60 min, from about 1 min to about 30 min, from about 5 min to about 45 min, from about 10 min to about 55 min, from about 15 min to about 55 min, from about 25 min to about 60 min.

In some embodiments, the temperature of the contacting step can vary. In some embodiments, the temperature at which the contacting step occurs ranges from about −20° C. to about 40° C., from about −19° C. to about 39° C., from ° C., from about −17° C. to about 36° C., from about −15° C. to about 32° C., from about −10° C. to about 30° C., from about −5° C. to about 25° C., from about −2° C. to about 21° C., from about 0° C. to about 16° C.

In some embodiments, the methods A, B, and C above comprise contacting a desired area with a noncorrosive nitrapyrin formulation at a rate of about 100 g to about 120 g per acre of the noncorrosive nitrapyrin formulation. The noncorrosive nitrapyrin formulation can, in some embodiments, be in solution at an amount of about 0.5 lbs to about 4 lbs per US gallon, or from about 1 lb to about 3 lbs per US gallon, or about 2 lbs per US gallon. In some embodiments, the method includes contacting the desired area at a rate of about 0.5 to about 4 qt/A, or about 1 to about 2 qt/A.

Particular embodiments of the subject matter described herein include:
1. A corrosion inhibitor composition for nitrapyrin-containing compositions comprising:
   an amine-based corrosion inhibitor selected from a neutralizing amine, a film-forming amine, and a combination thereof; and
   a solvent selected from a glycol ether, a methylated seed oil, and a combination thereof,
   wherein the amine-based corrosion inhibitor is present at a concentration of at least 50% by weight based on the total weight of the corrosion inhibitor composition.
2. The corrosion inhibitor composition of embodiment 1, wherein the neutralizing amine is selected from the group consisting of cyclohexylamine (CHA), methoxypropylamine (MPA), monoethanolamine (MEA), morpholine (MOR), 3-methoxypropylamine (MOPA), ethylamine (ET), dimethylamine (DMA), 1,8-dia 1,8-Diazabicyclo(5.4.0)undec-7-ene (DBU), 2-diethylaminoethanol (DEAE), triethanolamine (TEA), monoethanolamine (EA), diethanolamine (DEA), diethylhydroxylamine (DEHA), methyldiethanolamine (MDEA), and a combination thereof.
3. The corrosion inhibitor composition of embodiment 2, wherein the neutralizing amine is selected from monoethanolamine (EA), diethanolamine (DEA), methyldiethanolamine (MDEA), and a combination thereof.
4. The corrosion inhibitor composition of embodiment 1, wherein the film-forming amine is a fatty amine of formula (I):

R₁—[NH—R₂]ₙ—NH₂
wherein n is an integer between 0 and 7,
R₁ is a substituted or unsubstituted (C₁₀-C₂₂) alkyl group, and
R₂ is a substituted or unsubstituted (C₂-C₁₀) alkyl group.
5. The corrosion inhibitor composition of any above embodiment, wherein the solvent is a glycol ether selected from ethylene glycol monomethyl ether, ethylene glycol monoethyl ether, ethylene glycol monopropyl ether (propyl cellosolve), ethylene glycol monoisopropyl ether, ethylene glycol monobutyl ether, ethylene glycol monophenyl ether, ethylene glycol monobenzyl ether, propylene glycol methyl ether, diethylene glycol monomethyl ether, diethylene glycol monoethyl ether, diethylene glycol mono-n-butyl ether, dipropyleneglycol methyl ether, 2-butoxyethanol (butyl cellosolve), ethylene glycol monohexyl ether (hexyl cellosolve), and a combination thereof.
6. The corrosion inhibitor composition of any above embodiment, wherein the solvent is selected from butyl cellosolve, propyl cellosolve, hexyl cellosolve, diethylene glycol monoethyl ether, dipropylene glycol monomethyl ether, methylated seed oil, and a combination thereof.
7. The corrosion inhibitor composition of any above embodiment, wherein the solvent is present at a concentration of from about 0.01% to about 50% by weight based on the total weight of the corrosion inhibitor composition.
8. The corrosion inhibitor composition of any above embodiment, wherein amine-based corrosion inhibitor is ethanolamine and the solvent is selected from butyl cellosove, hexyl cellusolve, triethylene glycol monomethyl ether, methylated seed oil, and a combination thereof.
9. The corrosion inhibitor composition of any above embodiment, wherein the solvent is butyl cellosolve and the amine-based corrosion inhibitor is selected from ethanolamine, diethanolamine, and a combination thereof.
10. The corrosion inhibitor composition of any above embodiment, further comprising an additive selected from a surfactant, a dispersant, an emulsifier, an antifoam agent, a stability agent, a basic material, and a combination thereof.
11. A corrosion inhibitor formulation comprising:
   a corrosion inhibitor composition of any one of embodiments 1-9; and
   an organic solvent,
12. The formulation of embodiment 11, wherein the corrosion inhibitor composition is present in an amount of from about 0.1 to about 5% by weight based on the total weight of the formulation when mixed with a nitrapyrin containing composition.
13. The formulation of embodiment 11 or 12, wherein the organic solvent comprises at least one polar organic solvent.
14. The formulation of embodiment 13, wherein the polar organic solvent is selected from the group consisting of polyethylene glycol 3350, Agnique AMD3L, Rhodiasol PolarClean, dimethyl sulfoxide, sulfolane, propane-1,2,3-triol, xylenes, and mixtures thereof.
15. The formulation of any one of embodiments 11, 12, 13, or 14, further comprising a surface active agent, an antifoam agent, a dispersant, or a combination thereof.
16. The formulation of any one of embodiments 11, 12, 13, 14, or 15, wherein the formulation exhibits a reduced corrosion behavior compared to nitrapyrin formulations that do not contain a corrosion inhibitor composition of embodiment 1.
17. The formulation of any one of embodiments 11, 12, 13, 14, 15, or 16, wherein the formulation exhibits a reduced corrosion behavior towards metal-based materials used in agricultural equipment.
18. The formulation of embodiment 17, wherein the metal-based material contains aluminum, mild steel, iron, carbon steel, steel alloys, and a combination thereof.
19. The formulation of any one of embodiments 11, 12, 13, 14, 15, 16, 17, or 18, wherein the nitrapyrin containing composition is a commercially available nitrapyrin-containing product.
20. A method of making a noncorrosive nitrapyrin formulation, comprising:
   contacting a nitrapyrin-containing composition with a corrosion inhibitor composition of any one of embodiments 1-9 to form the noncorrosive nitrapyrin formulation.
21. The method of embodiment 20, wherein the nitrapyrin-containing composition comprises a nitrapyrin concentration of from about 1% to about 50% by weight based on the total weight of the nitrapyrin-containing composition.
22. The method of embodiment 20 or 21, wherein the nitrapyrin-containing composition is a commercially available nitrapyrin-containing composition selected from N-Serve and Instinct.
23. A method of reducing corrosion of metal-based material used in agricultural equipment, the method comprising:
   obtaining a corrosion inhibitor formulation according to any one of embodiments 11-19; and
   contacting a metal surface with the noncorrosive nitrapyrin formulation for a period of time.
24. The method of embodiment 23, wherein the metal surface is part of a metal-based material used in agriculture.
25. The method of embodiment 23 or 24, wherein the metal surface comprises aluminum and/or mild steel.
26. The method of any one of embodiments 23-25, wherein the contacting of the metal surface with the noncorrosive nitrapyrin formulation occurs at a temperature ranging from −20° C. to about 40° C.
27. The method of any one of embodiments 23-26, wherein the period of time ranges from 1 second to about 24 hours.
28. The method of any one of embodiments 23-26, wherein the obtaining step and the contacting step are carried out within 24 hours.
29. The method of any one of embodiments 23-28, wherein corrosion is reduced by at least 10% compared to nitrapyrin formulation that are not contacted with the corrosion inhibitor composition.

### EXAMPLES

It should be understood that the following examples are provided by way of illustration only and nothing therein should be taken as a limiting factor.

### Example 1. Noncorrosive Formulations

The following formulations were prepared and measured according to ASTM D-2688 standard, entitled “Corrosivity of Water in the absence of Heat Transfer (Weight Loss Methods),” for their corrosive behavior. The tests were designed to compare the formulations containing nitrapyrin complexes with N-Serve and/or Instinct II, the two commonly used and commercially available nitrapyrin formulations.

containing nitrapyrin complexes with N-Serve and/or Instinct II, the two commonly used and commercially available nitrapyrin formulations.

In particular, the above formulations were tested as outlined in the procedure as follows: Mild cold rolled steel coupons meeting the standard ASTM A1008/A366 measuring 3.0″×0.75″ were cleaned by submersion in acetone with gentle agitation for ˜3 minutes and rinsed with deionized water and dried thereafter. Once dried, the coupons were weighed and their weight was recorded. Coupons were then placed into 50 ml conical tubes with 10 grams of the various formulations and tightly capped. These samples were intermittently placed in a ˜54° C. oven (total time 24 hours) or left at room temperature (˜21° C.) for approximately 21 days. At the end of the incubation period the metal coupons were removed from the conical tubes and cleaned using deionized water and wiped with a paper towel to remove any loose particulates. The coupons were thoroughly dried, and their weight recorded. Coupon weight before is the weight of the coupon before being placed in the conical tube with the formulation. Conical weight after is the weight of the coupon upon removal of the coupon from the formulation after incubation and after cleaning. Weight loss, % is Starting weight minus Final weight.

1. A corrosion inhibitor composition for nitrapyrin-containing compositions comprising:
an amine-based corrosion inhibitor selected from a neutralizing amine, a film-forming amine, and a combination thereof; and
a solvent selected from a glycol ether, a methylated seed oil, and a combination thereof,
wherein the amine-based corrosion inhibitor is present at a concentration of at least 50% by weight based on the total weight of the corrosion inhibitor composition.

2. The corrosion inhibitor composition of claim 1, wherein the neutralizing amine is selected from the group consisting of cyclohexylamine (CHA), methoxypropylamine (MPA), monoethanolamine (MEA), morpholine (MOR), 3-methoxypropylamine (MOPA), ethylamine (ET), dimethylamine (DMA), 1,8-dia 1,8-Diazabicyclo(5.4.0)undec-7-ene (DBU), 2-diethylaminoethanol (DEAE), triethanolamine (TEA), monoethanolamine (EA), diethanolamine (DEA), diethylhydroxylamine (DEHA), methyldiethanolamine (MDEA), and a combination thereof.

3. (canceled)

4. The corrosion inhibitor composition of claim 1, wherein the film-forming amine is a fatty amine of formula (I):
R₁—[NH—R₂]ₙ—NH₂
wherein n is an integer between 0 and 7,
R₁ is a substituted or unsubstituted (C₁₀-C₂₂) alkyl group, and
R₂ is a substituted or unsubstituted (C₂-C₁₀) alkyl group.

5. The corrosion inhibitor composition of claim 1, wherein the solvent is a glycol ether selected from ethylene glycol monomethyl ether, ethylene glycol monoethyl ether, ethylene glycol monopropyl ether (propyl cellosolve), ethylene glycol monoisopropyl ether, ethylene glycol monobutyl ether, ethylene glycol monophenyl ether, ethylene glycol monobenzyl ether, propylene glycol methyl ether, diethylene glycol monomethyl ether, diethylene glycol monoethyl ether, diethylene glycol mono-n-butyl ether, dipropyleneglycol methyl ether, 2-butoxyethanol (butyl cellosolve), ethylene glycol monohexyl ether (hexyl cellosolve), and a combination thereof.

6. (canceled)

7. The corrosion inhibitor composition of claim 6, wherein the solvent is present at a concentration of from about 0.01% to about 50% by weight based on the total weight of the corrosion inhibitor composition.

8. The corrosion inhibitor composition of claim 1, wherein amine-based corrosion inhibitor is ethanolamine and the solvent is selected from butyl cellosove, hexyl cellusolve, triethylene glycol monomethyl ether, methylated seed oil, and a combination thereof.

9. The corrosion inhibitor composition of claim 1, wherein the solvent is butyl cellosolve and the amine-based corrosion inhibitor is selected from ethanolamine, diethanolamine, and a combination thereof.

10. (canceled)

11. A corrosion inhibitor formulation comprising:
a corrosion inhibitor composition of claim 1; and
an organic solvent,

12. The formulation of claim 11, wherein the corrosion inhibitor composition is present in an amount of from about 0.1 to about 5% by weight based on the total weight of the formulation when mixed with a nitrapyrin-containing composition selected from N-Serve and Instinct.

13. The formulation of claim 11, wherein the organic solvent comprises at least one polar organic solvent selected from the group consisting of polyethylene glycol 3350, Agnique AMD3L, Rhodiasol PolarClean, dimethyl sulfoxide, sulfolane, propane-1,2,3-triol, xylenes, and mixtures thereof.

14. (canceled)

15. (canceled)

16. The formulation of claim 11, wherein the formulation exhibits a reduced corrosion behavior compared to nitrapyrin formulations that do not contain a corrosion inhibitor composition of claim 1.

17. The formulation of claim 11, wherein the formulation exhibits a reduced corrosion behavior towards metal-based materials used in agricultural equipment, wherein the metal-based material contains aluminum, mild steel, iron, carbon steel, steel alloys, and a combination thereof.

18. (canceled)

19. (canceled)

20. (canceled)

21. (canceled)

22. (canceled)

23. A method of reducing corrosion of metal-based material used in agricultural equipment, the method comprising:
obtaining a corrosion inhibitor formulation according to claim 11; and
contacting a metal surface with the noncorrosive nitrapyrin formulation for a period of time, wherein the metal surface comprises aluminum and/or mild steel.

24. (canceled)

25. (canceled)

26. The method of claim 23, wherein the contacting of the metal surface with the noncorrosive nitrapyrin formulation occurs at a temperature ranging from −20° C. to about 40° C.

27. (canceled)

28. (canceled)

29. The method of claim 23, wherein corrosion is reduced by at least 10% compared to nitrapyrin formulation that are not contacted with the corrosion inhibitor composition.
